(19) United States
(12) Patent Application Publication
(10) Pub. No.: US 2005/0278328 A1
(43) Pub. Date: Dec. 15, 2005

(54) Sorting and filtering techniques for products, namely posters and artwork

(76) Inventors: Michael John Marston, Raleigh, NC (US); Andrew Randall Villalobos, Garner, NC (US)

Correspondence Address: WITHROW & TERRANOVA, P.L.L.C., P.O. BOX 1287, CARY, NC, 27512, US

(21) Appl. No.: 10/860,932

(22) Filed: Jun. 4, 2004

(51) Int. Cl. G06F 7/00

(52) U.S. Cl. 707/7

(57) ABSTRACT

A system and method for sorting and filtering products selected by a user. The products may be displayed on a graphical user interface, such as an Internet browser, on a user's computer. The user's computer is communicatively coupled to a web server that creates web pages in response to a user's request for display of products. The user can makes requests for the display of products, namely posters and artwork, framed and unframed. The user can sort the artwork by various parameters, including size, popularity, most recent, and availability. The user can filter the artwork by size and price options. The filter criteria selected by the user remains in force for the user during his or her entire session unless the filter criteria is modified.

### FIELD OF THE INVENTION

The present invention relates to sorting and filtering techniques for products offered for viewing and sale on a web site, including posters and artwork, framed and unframed.

### BACKGROUND OF THE INVENTION

Internet browsers and web servers are commonly used for carrying out transactions over the Internet. A company selling a product or service can provide a web site by providing a web server having an Internet Protocol (IP) address on the Internet that is accessible via a Uniform Resource Locator (URL). A user or customer can gain access to the web site by entering the domain name of the site into the address space of the user's Internet browser. The browser is communicatively coupled to the web server via data packet transfer over the Internet. The web server downloads an initial web page in the form of a hypertext markup language (HTML) to the user's browser. Thereafter, the user can make selections provided in the form of links on the web page to make subsequent requests to the web server.

In order to provide a beneficial experience to customers accessing a web site over the Internet where goods and services can be requested, the web site must be designed to foster efficiency, ease of use, and convenience to the user. The user must be able to find the product or service that he or she desires and be able to purchase such product or service in a manner that fosters loyalty. If the user is not able to easily navigate a web site using a browser to make purchase and/or other selections, the user will not frequent the web site and the company will lose business as a result.

An example of a retail web site on the Internet is the Art.com web site located at www.art.com. Art.com sells posters and artwork, both framed and unframed, over the Internet like many other Internet-based companies. The user makes requests for reviewing and selecting posters and artwork for purchase. In order to foster a beneficial experience to the user, the user must be able to easily review and select posters and artwork for purchase on the Art.com web site. The term “posters” and “artwork” are used interchangeably herein. The user must be able to navigate the web site to find a poster that meets the user's selection criteria. The user may desire to find posters having a certain size so that the poster can be displayed on wall of a given size. Or the user may have certain budget guidelines that only allow the user to purchase a poster in a given price range. The user may desire to find posters by a particular artist, subject area, or other criteria. In order to find posters on the Art.com web site, the user is able to enter a keyword for searching, or select categories of posters, also called galleries, that are organized by topic. Once the user has initiated a search request or a selection of a category of posters to be displayed on their browser, all of the posters meeting the user's selection criteria are sent by the Art.com web site to the user's browser to be displayed.

Some categories of posters may contain more posters than can be shown on a single web page. Some categories may contain hundreds of different pieces of artwork that the customer may have to peruse to find his or her desired selection. One solution to prevent the user from having to peruse numerous posters in a given category of posters is to form more narrowly tailored categories containing less pieces per category. For example, all of the posters by the artist Monet can be further separated by subcategories of periods of time of creation. However, more categories may actually detract from the user's retail experience since the user may have to select several categories of posters to review posters having a common interest or topic.

Therefore, in order to improve the experience to the user at the Art.com web site and other transaction web sites, there exists a need to provide a user the ability to review posters and other products in an efficient manner to provide a beneficial experience to the user and build customer loyalty.

### SUMMARY OF THE INVENTION

The present invention provides sorting and filtering techniques for a user to more easily navigate a transaction web site or other computer system. In the particular example discussed in this application below, the website is the URL domain name www.art.com. The products being sorted and filtered are posters. Posters may be either framed or unframed.

The user initially requests posters and artwork to be displayed in a product display area of a web page by either selecting a gallery or initiating a search request. The user's request is communicated from the user's browser over the Internet to a web server. If a gallery is selected, the web server displays the galleries that comply with the user's request. For example, the user may request the web server to create a web page with poster galleries based on a subject area, an artist's name, a collections, or posters that are on clearance, limited editions or best sellers. If the user initiates a search request, the web server finds galleries that meet or closely match the search criteria. The web server builds a web page that sends a list of galleries meeting the search criteria to the user's browser with the posters from the poster gallery most closely meeting the user's search (called “current gallery”) being displayed in a poster display area.

The posters displayed in the poster display area are sorted automatically by default according to the most popular being shown first to the least popular being shown last. The user can then perform other sort requests on the posters in the current gallery according to various methods, some of which are related directly to criteria present for poster products that do not apply to other types of products, like height, width, portrait and landscape size constraints for example. The user selects the sort type to be requested from the web server by selecting one of a list of sorting options in a drop down menu on the web page on the user's browser.

The user can choose to sort the posters displayed in the current gallery by most popular, highest to lowest price, lowest to highest price, the highest discount price, the largest to smallest width, the smallest to largest width, the largest to smallest height, the smallest to largest height, the largest to smallest square size, the smallest to largest square size, the availability of most available to least available, and the most recently added to least recently added posters to the retail web site. In this manner, the user can easily and quickly navigate posters displayed in the poster display area on the web page to select posters, including those for purchase, according to criteria that is specific to their needs for posters and thus improve their experience.

The user can also choose to filter posters displayed in the current gallery by filtering criteria, some of which is specific to poster products in particular. The user makes a filter request on the web page displayed on their browser by selecting the “narrow selection” link. The web server in turn downloads a Java script file containing an executable user interface for filtering selections that can be made by the user, called the “narrow selection interface” or “filter interface.” Thereafter, if the user makes subsequent filtering requests, the narrow selection interface does not have to be downloaded again to the browser. The narrow selection interface is resident on the user's computer in the form of a Java script file to execute locally on the user's browser for each time the user selects the “narrow selection” link for filtering.

The user can choose to filter posters displayed in a gallery based on narrow selection criteria, which may be based on price or size, for example. When filtering on price, the user can filter to include posters of all sizes, posters within a custom price range. The user has the ability to set the low price and the high price for a custom price filter selection to establish a price range so that only posters having a retail price within the price range are displayed on the user's browser. The user can also filter posters based on size, including the display of all sizes, only portrait style sizes, only landscape style sizes, or based on a custom height and width range. In this manner, only posters meeting the user's desired price and/or sizing requirements are displayed to the user to minimize the user's time in reviewing and traversing posters displayed on the user's browser and thus improving the experience of the user.

Another important aspect of the present invention is that the narrow filtering criteria selected by the user is stored in the session database at the web server for the user. In this manner, the narrow selection criteria is retained for the user for the user's entire session. Subsequent searches or category requests for display of posters will cause the web server to filter the displayed posters in the poster display area automatically based on the previously stored filter selection criteria stored without the user having to enter the narrow selection criteria at the narrow selection interface again. The user can choose to modify the narrow selection criteria or remove the narrow selection criteria if they so desire, and if done, subsequent searches will use the most recent narrow selection criteria stored for the user, if any.

The present invention is not limited to a browser that connects to the web site via the Internet. The present invention can be implemented using any computer system having an input and output interface that is coupled via a communication network to a server. Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 is an illustration of the Art.com website homepage displayed on a user's browser;

FIG. 2 is an illustration of the communication and system architecture of the Art.com system;

FIG. 3 is a flowchart illustration of a “most popular” sort performed by the Art.com system in response to a search request by a user;

FIGS. 4A and 4B are an illustration of a “most popular” sort result web page generated by the Art.com system and displayed on the user's browser according to the flowchart in FIG. 3;

FIG. 5 is a flowchart illustration of a ranking system used to assign a rank to posters for use by the Art.com system to determine the popularity of posters;

FIG. 6 is a flowchart illustration of a “price (high to low)” sort performed by the Art.com system in response to a request by the user for posters to be sorted from highest price to lowest price;

FIGS. 7A and 7B are an illustration of “price (high to low)” sort result web page generated by the Art.com system and displayed on the user's browser according to the flowchart in FIG. 6;

FIG. 8 is a flowchart illustration of a “price (low to high)” sort request performed by the Art.com system in response to a request by the user for posters to be sorted from the lowest price to the highest price;

FIGS. 9A and 9B are an illustration of a “price (low to high)” sort result web page generated by the Art.com system and displayed on the user's browser according to the flowchart in FIG. 8;

FIG. 10 is a flowchart illustration of a “highest discount percentage” sort request performed by the Art.com system in response to a request by the user for posters to be sorted according to the highest discount price to the lowest discount price;

FIGS. 11A and 11B are an illustration of a “highest discount percentage” sort result web page generated by the Art.com system and displayed on the user's browser according to the flowchart in FIG. 10;

FIG. 12 is a flowchart illustration of a “size (width, largest to smallest)” sort request performed by the Art.com system in response to a request by the user for posters to be sorted according to largest width size to the smallest width size;

FIGS. 13A and 13B are an illustration of a “size (width, largest to smallest)” sort result web page generated by the Art.com system and displayed on the user's browser according to the flowchart in FIG. 12;

FIG. 14 is a flowchart illustration of a “size (width, smallest to largest)” sort request performed by the Art.com system in response to a request by the user for posters to be sorted according to smallest width size to the largest width size;

FIGS. 15A and 15B are an illustration of a “size (width, smallest to largest)” sort result web page generated by the Art.com system displayed on the user's browser according to the flowchart in FIG. 14;

FIG. 16 is a flowchart illustration of a “size (height, largest to smallest)” sort request performed by the Art.com system in response to a request by the user for posters to be sorted according to largest height size to the smallest width size;

FIGS. 17A and 17B are an illustration of a size (height, largest to smallest)” sort result web page generated by the Art.com system displayed on the user's browser according to the flowchart in FIG. 16;

FIG. 18 is a flowchart illustration of a “size (height, smallest to largest)” sort request performed by the Art.com system in response to a request by the user for posters to be sorted according to smallest height size to the largest width size;

FIGS. 19A and 19B are an illustration of a size (height, smallest to largest)” sort result web page generated by the Art.com system displayed on the user's browser according to the flowchart in FIG. 18;

FIG. 20 is a flowchart illustration of a “size (square, largest to smallest)” sort request performed by the Art.com system in response to a request by the user for posters to be sorted according to largest square size to the smallest square size;

FIGS. 21A and 21B are an illustration of a size (square, largest to smallest)” sort result web page generated by the Art.com system displayed on the user's browser according to the flowchart in FIG. 20;

FIG. 22 is a flowchart illustration of a “size (square, smallest to largest)” sort request performed by the Art.com system in response to a request by the user for posters to be sorted according to smallest square size to the largest square size;

FIGS. 23A and 23B are an illustration of a size (square, smallest to largest)” sort result web page generated by the Art.com system displayed on the user's browser according to the flowchart in FIG. 22;

FIG. 24 is a flowchart illustration of a “product availability” sort request performed by the Art.com system in response to a request by the user for posters to be sorted according to most available products to least available products;

FIGS. 25A and 25B are an illustration of a “product availability” sort result web page generated by the Art.com system displayed on the user's browser according to the flowchart in FIG. 24;

FIG. 26 is a flowchart illustration of a “most recently added” sort request performed by the Art.com system in response to a request by the user for posters to be sorted according to products most recently added to the Art.com system to products least recently added to the Art.com system;

FIGS. 27A and 27B are an illustration of a “most recently added” sort result web page generated by the Art.com system displayed on the user's browser according to the flowchart in FIG. 26;

FIG. 28 is a flowchart illustration of a narrow selection request performed by the Art.com system in response to a request by the user to filter posters displayed on the user's browser;

FIGS. 29A and 29B are an illustration of the narrow selection interface downloaded by the Art.com system to the user's browser according to the “price” tab being selected by the user;

FIG. 30 is a flowchart illustration of a “custom price” narrow selection request performed by the Art.com system in response to a request by the user to filter posters according to a custom priced entered in the narrow selection interface;

FIGS. 31A and 31B are an illustration of the narrow selection interface according to the “size” tab being selected by the user;

FIG. 32 is a flowchart illustration of a “portrait” size narrow selection request performed by the Art.com system in response to a request by the user to filter posters to select on those of a portrait type;

FIG. 33 is a flowchart illustration of a “landscape” size narrow selection request performed by the Art.com system in response to a request by the user to filter posters to select on those of a landscape type; and

FIG. 34 is flowchart illustration of a “custom” size narrow selection request performed by the Art.com system in response to a request by the user to filter posters based on a custom size.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

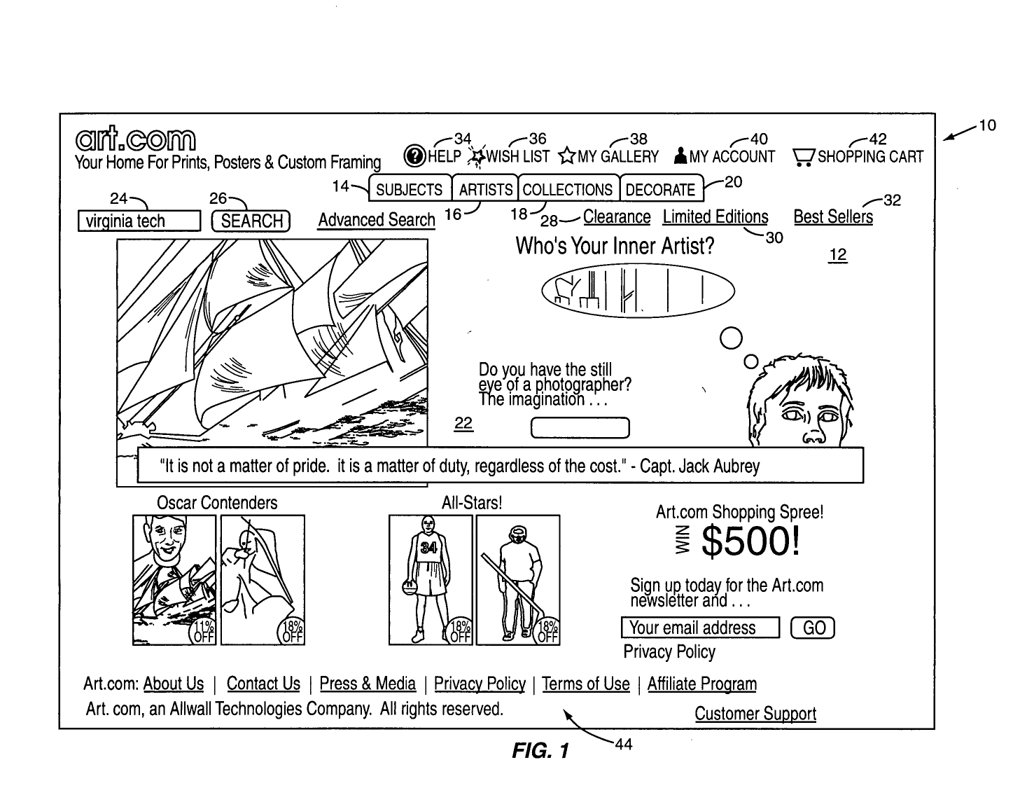

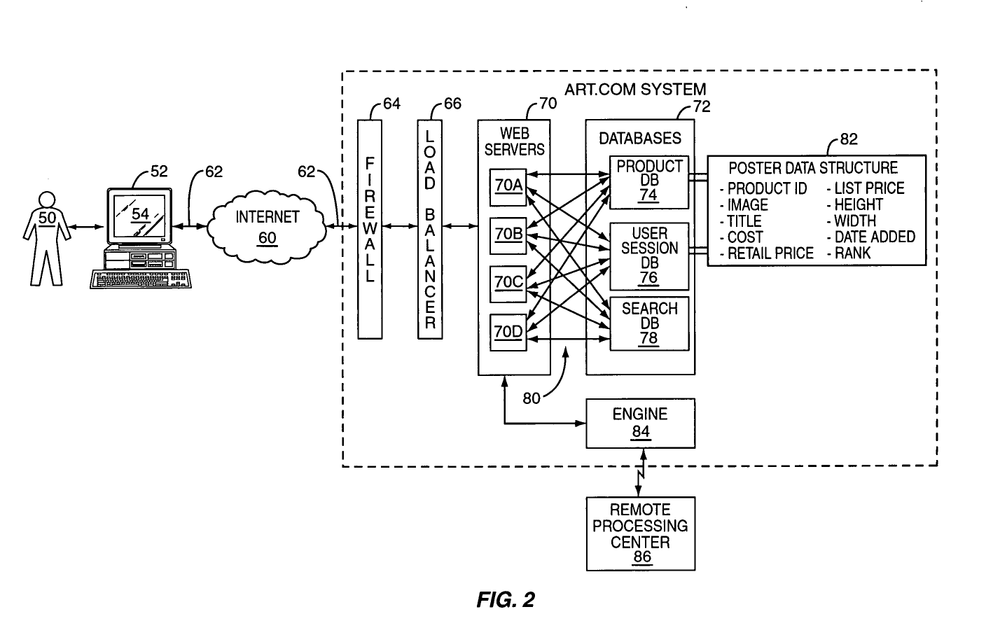

The present invention generally relates to sorting and filtering techniques regarding search results obtained and displayed via interaction with a website. In the particular example discussed below, the website is the URL domain name www.art.com, and the products that are being sorted and filtered are posters or artwork. The term “poster” is used interchangeably with “artwork” in this application. Posters may be either framed or unframed. Artwork can include pictures and other displays in any other type of visual form. Some of the sorting and filtering techniques described herein are specific to functionality for posters in particular; however, please note that the sorting and filtering techniques described herein may be applicable for other products in addition to posters. Before discussing the specific aspects of the sorting and filtering techniques of the present invention, a description of the Art.com system follows in FIGS. 1 and 2 below.

FIG. 1 illustrates a web page 10 that is the home page 12 of the website www.art.com, also referred to as the “Art.com system” or “Art.com website.” The web page 10 is generated by the Art.com system, as will be described below for FIG. 2, and sent is to a user via a web browser or other graphical display. The web page 10 allows a user to select posters to be displayed by various categories. For example, a user can select posters to be displayed on the web page 10 by subject area by selecting a “Subjects” tab 14. The user can select posters to be displayed on the web page 10 by the artist's name by selecting an “Artists” tab 16. The user may also select posters to be displayed on the web page 10 according to various collections of posters by selecting a “Collections” tab 18. Or the user can select posters based on a decorating section on the web page 10 by selecting a “Decorate” tab 20. For whatever action the user selects on the web page 10, the results of such action are displayed in a display area 22 of the web page 10. In FIG. 1, the display area 22 contains the default home page of the Art.com website.

In addition to the user being able to select posters according to various categories as discussed above, the user can also search for posters by entering search text into a search field 24. After the user enters the text to be searched in the search field 24, the user directs the Art.com website to initiate the search and display the results by selecting a “Search” link 26. Thereafter, the Art.com website will search for posters that meet the search criteria according to the search text entered into the search field 24 and will generate a web page consisting of different categories of posters meeting the search criteria to be displayed in the display area 22 as a result thereof. Because the example of the present invention relates to sorting and filtering techniques of posters displayed in the display area 22 of the web page 10, it is necessary that the user initiate a selection (by selecting one of the tabs 14-20) or a search (by initiating a search request by selecting the search link 26) for posters to be displayed in the display area 22 of the web page 10.

The home page 12 displayed in FIG. 1 also contains other methods for a user to display posters in the display area 22. For example, the user could select a “Clearance” link 28 which causes the Art.com website to display posters designated for clearance. The user could also select a “Limited Editions” link 30 to request the Art.com website to display posters that are limited editions in the display area 22. The user could also select a “Best Sellers” link 32 to request the Art.com website to display posters designated as best sellers in the display area 22. Any of the above mentioned methods of requesting posters to be displayed in the display area 22 can be used by the user to display posters and to perform the sorting and filtering techniques of the present invention, as described below.

The Art.com home page 12 also contains various other links that are not directly related to the present invention. For example, these links include the “Help” link 34 that can be selected by the user to display help instructions in the display area 22. The user may also select the “Wish List” link 36 or “My Gallery” link 38 to display a user's wish list or gallery selections. The user may also select the “My Account” link 40 to display information regarding the user's account in the display area 22. The user may also select the “Shopping Cart” link 42 to display posters or other products offered by the Art.com website that have been selected by the user for purchase. Other links regarding the Art.com website are shown on the home page 12 in FIG. 1 as links 44.

FIG. 2 illustrates the system and communication architecture of the Art.com system whereby a user 50 can access the Art.com website via the Internet to conduct transactions, including the request for display of posters and sorting and filtering of such according to the present invention. As illustrated in FIG. 2, a user 50 interacts with a computing device or computer 52. The computer 52 includes a display 54 that typically runs an Internet browser to display information received over the Internet 60 and send information out over the Internet 60. The computer 52 is coupled to the Internet 60 via a communication link 62 to accomplish data packet transfer as is well known. Messages sent by the computer 52 over the Internet 60 that are destined for the Art.com IP address are delivered to the Art.com system as illustrated in FIG. 2.

A data packet sent by the computer 52 that is received by the Art.com system first encounters a firewall 64 to provide security and limited access into the Art.com system from the Internet 60. The data packet is next communicated to a load balancer 66 that then directs the message to one of a plurality of redundant web servers 70. In FIG. 2, four web servers are shown, web servers 70A, 70B, 70C, 70D. In this manner, the Art.com system has sufficient computing power to handle traffic from a plurality of computers 52 simultaneously. The web servers 70 are coupled with various databases 72 that are part of the Art.com system and necessary for operation of the Art.com system.

The databases 72 in the Art.com system include a product database 74, a user session database 76, and a search database 78. The web servers 70 are communicatively coupled to these databases 72 via communication links 80. Communication links 80 are provided between every web server 70 and every database 72 so that each web server 70 is able to communicate with any database 72 for operation of the system. The web servers 70 contain the logic that generates the web pages sent to the user 50 over the Internet 60. The web server 70 accesses the databases 72 to retrieve information about products, namely posters, which are available for display and ordering by the user 50 via the Art.com system.

The user session database 76 is used to store an instance of an ongoing session established by the user 50 with the web server 70, such as when a customer logs into the Art.com system using his or her account name and password. The product database 74 contains information about each of the posters that are available to be displayed and ordered by the user 50 via interaction with the web server 70. The search database 78 contains cached search results based on the search request made by the web servers 70 to the product database 74. The web servers 70 check the search database 78 in response to a search request to determine if the search request desired is already stored in the search database 78. In this manner, the web server 70 is able to more quickly execute search requests by the user.

Within both the product database 74 and the search database 78 are contained poster data structures 82 that contain vital information about each of the posters available for display and ordering by the user 50 via interaction with the Art.com system. The poster data structure 82 is used to perform the various sorting and filtering techniques that are part of the present invention as well. The poster data structure 82 includes a product ID for the poster that is used to uniquely store each poster as a separate product in the databases 72. The poster data structure 82 also contains an image file name that is a file containing a graphic image of the poster to be used to display to a user 50. The poster data structure 82 also contains a title, cost, retail price and list price of a poster to be used by the web server 70 for various operations of the Art.com system. The poster data structure 82 also includes the height and width of the poster for sorting based on the height and width of the poster. The user 50 may decide to purchase a poster from the Art.com system based on height and width considerations. The poster data structure 82 also includes the date that the poster was added to the Art.com system and made available for access by a user 50 as well as a rank field that is indicative of which posters are ordered more often by users 50. The web server 70 is also coupled to an engine 84 that directs messages from the Art.com system to a remote processing center 86 for payment. The remote processing center 86 is used for processing of credit card accounts so that the user 50 can use his or her credit card account for the purchase of posters. The user's 50 account information is transmitted to the engine 84 and then to the remote processing center 86 to charge a user's 50 account for purchase of posters.

### Sorting Techniques

Most Popular

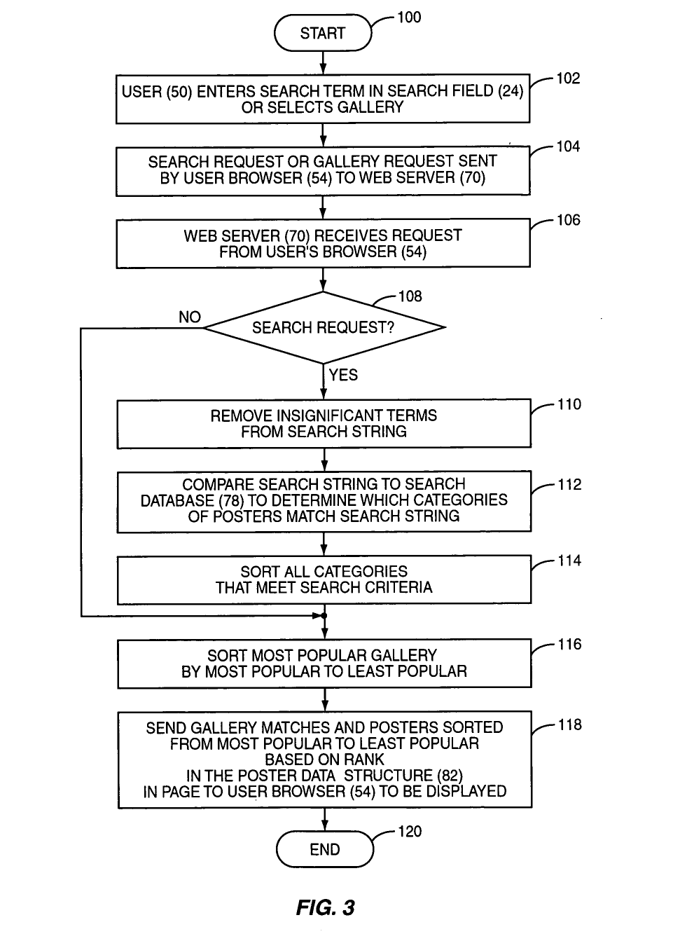

FIG. 3 illustrates a flowchart showing the operation of the web server 70 in the Art.com system when a user 50 enters a search term in the search field 24 or selects a gallery of posters to be displayed. The Art.com system initially displays the most popular poster in the gallery either searched or selected by the user 50 as the default display criteria on the web page 10.

The process starts (block 100), and the user 50 enters a search term for a poster to be searched in the search field 24 of the web page 10, or the user 50 selects a gallery of posters to be displayed using the tabs 14, 16, 18, 20 or links 28, 30, 32 on the web page 10. After the user 50 makes a request for a display of posters, the request is sent by the user's browser 54 to the web server 70 (block 104). The web server 70 receives the request from the user's browser 54 (block 106) and determines if the user's 50 request is a search request (decision 108). If the user's 50 request is a search request, the web server 70 removes insignificant terms from the search string entered by the user 50 in the search field 24 (block 110). Thereafter, the web server 70 compares the search string to key words in the search database 78 to determine which categories of posters match or closely match the search string (block 112). The web server 70 then sorts all of the poster categories that met the search criteria so that the categories can be displayed via the web page 10 back to the user 50 (block 114). Thereafter, the web server 70 sorts the poster galleries to find the most popular to least popular galleries based on all of the category results that resulted from block 112 (block 116). The web server 70 lastly sends a web page containing the poster gallery matches and posters sorted from most popular to least popular based on the rank in the poster data structure 82 for the most popular gallery to the user's browser 54 to be displayed in the form of a web page 10. Thereafter, the process ends (block 120).

If in decision 108, the user's 50 request for a display of posters was not a search request, then the web server 70 would not perform the steps in blocks 110 through 114. This is because the user 50 selected poster galleries to be displayed on the web page 10 based on selection criteria (such as by tabs 14, 16, 18, 20, for example) other than a search. In this instance, the web server 70 would skip the steps in blocks 110 through 114 and start at block 116 as previously described.

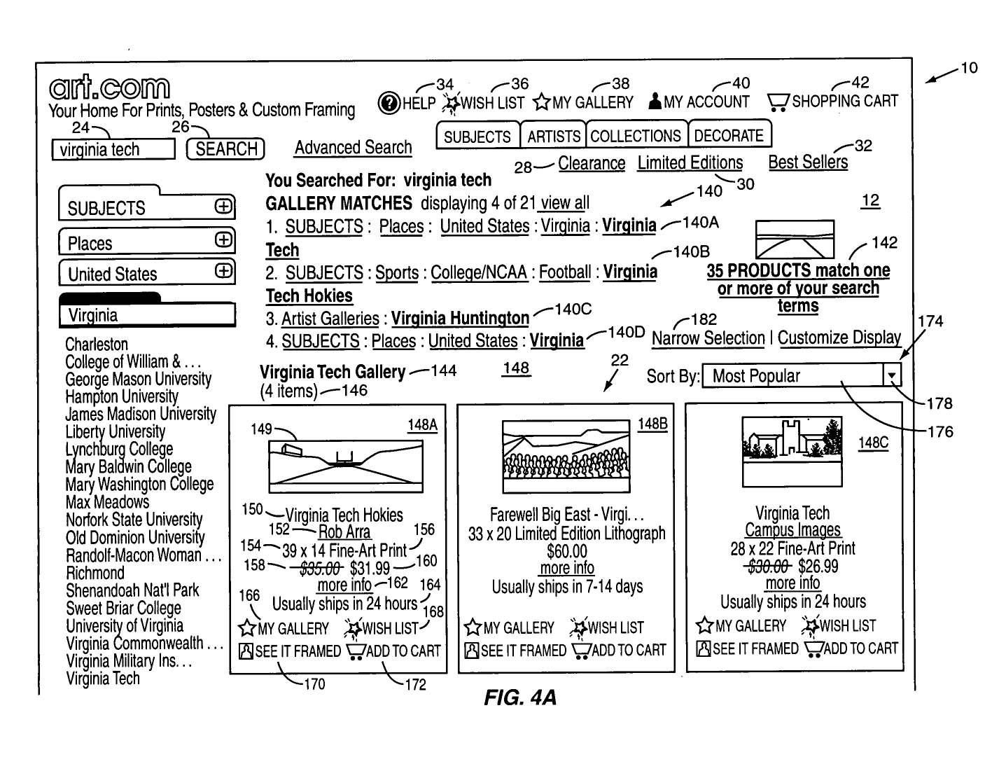

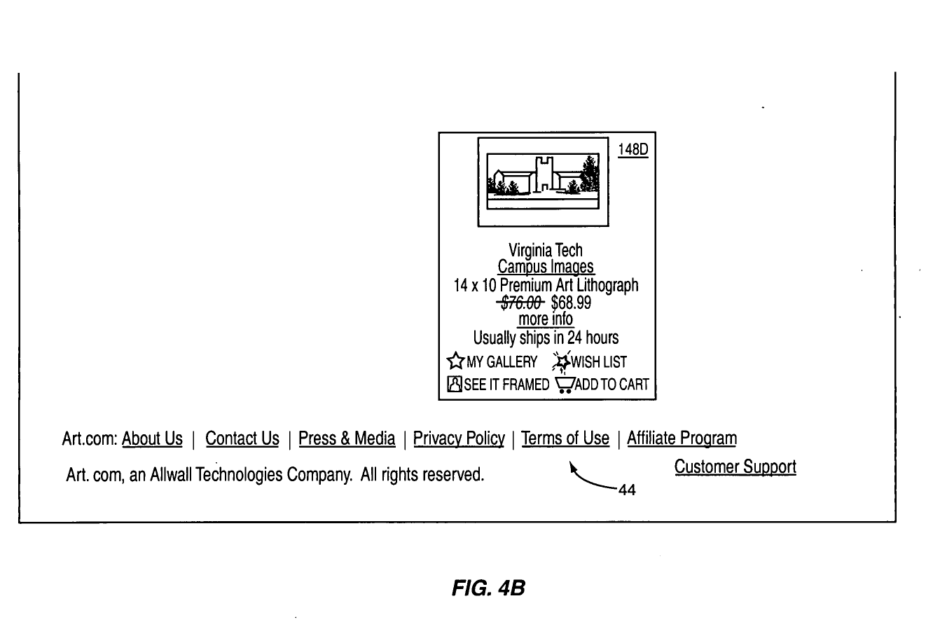

FIGS. 4A and 4B illustrate an example of the process described in FIG. 3 wherein a user 50 entered a search term in the search field 24 and initiated a search for posters to the web server 70. FIG. 4B is a continuation of the same web page 10 illustrated in FIG. 4A. In the present example as noted by the text in the search field 24, the user 50 desired to display posters based on the search term “Virginia Tech.” The web server 70, using the flowchart process described in FIG. 3, displayed each of the poster gallery matches for the search term “Virginia Tech” in the gallery matches list 140. The web server 70 displayed the total number of posters that met the search criteria using a poster match total 142. The web server 70 then formulated a web page 10 wherein the most popular gallery out of each of the gallery matches shown in the gallery matches list 140 is displayed at the most popular gallery 144, which in the present example is the “Virginia Tech” gallery.

The number of posters in the Virginia Tech gallery 144 is displayed in the number of items in gallery field 146, and each of these posters is displayed in detail in the poster display area 148. In the present example, since only four posters are contained in the Virginia Tech gallery 144, all four posters fit on a single web page 10 as illustrated in FIGS. 4A and 4B. If more posters were included in a most popular gallery 144 than can be displayed on a single web page 10, the web page 10 will display the most popular posters first and allow a user 50 to click on other links to gain access to the other posters not initially displayed in the poster display area 148.

In the present example, there are four posters displayed in the poster display areas 148A, 148B, 148C, and 148D. The poster displayed in poster display area 148A will be described herein, but its description and the contents within are also applicable to the poster display areas 148B, 148C and 148D as well. A poster picture 149 is displayed first in the poster display area 148A. This image is obtained from the image file stored in the poster data structure 82 for the poster. Next, the gallery name 150 of the poster, the artist 152, the dimensions 154 (comprised of a height and width from the poster data structure 82), and the poster type 156 are displayed. The retail price 158 and the list price 160 are displayed. The user 50 can select the more information link 162 to obtain more information about the poster. The shipment availability 164 is also displayed. The user 50 can select the poster in poster display area 148A to be added to his or her personalized gallery by selecting “My Gallery” link 166 or to his or her wish list by selecting the “Wishlist” link 168. The user 50 can also request a poster in the poster display area 148A to be framed by selecting the “See It Framed” link 170, or add a poster to his or her shopping cart via the “Add To Cart” link 172 for purchase.

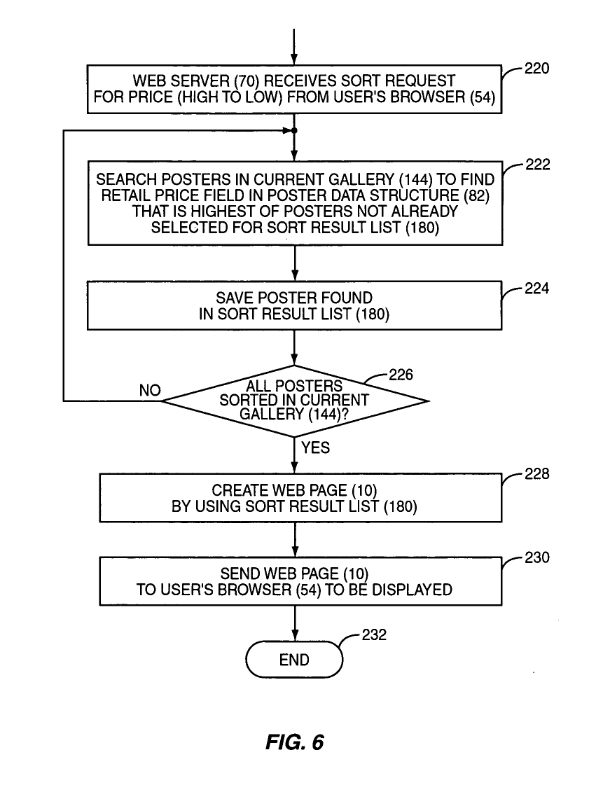

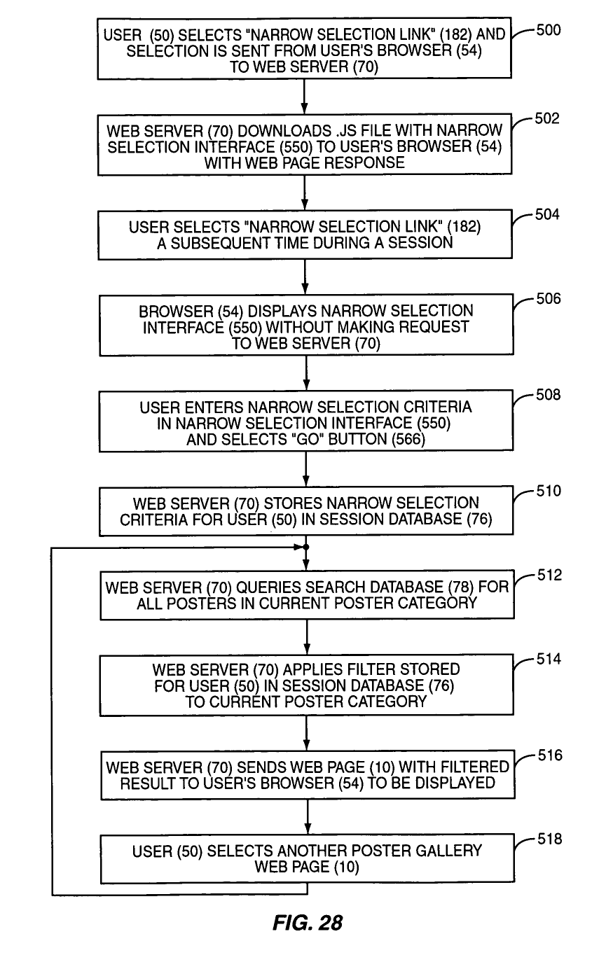

Note that the web page 10 illustrated in FIGS. 4A and 4B includes a “Sort By” dropdown box 174 which displays the current sort type 176 that was used by the web server 70 to arrange the order of posters displayed in the poster display area 148. In this particular example, the sort by type 176 is the “most popular,” meaning that the posters displayed in the poster display area 148 are displayed in order of most popular to least popular. The web server 70 defaults to “most popular” for initial search requests. The “Sort By” dropdown box 174 contains a “sort by” dropdown menu 178 that allows the user to sort the posters currently being displayed in the poster display area 148 by other sorting methods besides “most popular,” which are described in FIGS. 6 through 27 below. The user 50 can also filter the posters in the poster display area 148 by selecting the “narrow selection” link 182, which is described below starting with FIG. 28.

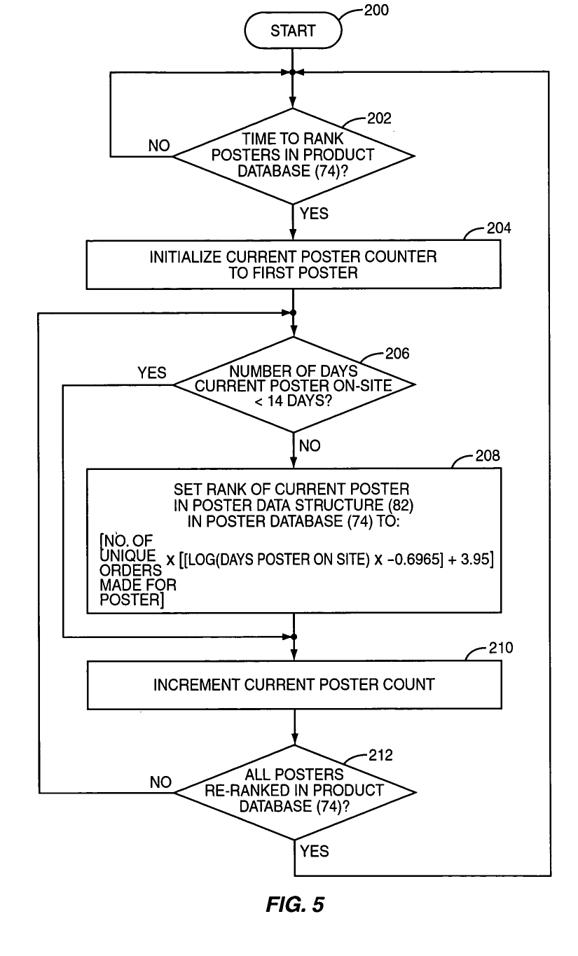

The web server 70 determines which posters are more popular than others to perform the functionality described in the flowchart in FIG. 3 and to create the web page 10 illustrated in FIGS. 4A and 4B. The web server 70 determines which posters are more popular than others in the poster gallery 144 displayed in the poster display area 148 using a rank assigned to each poster. The poster data structure 82 contains a rank field that is periodically updated for each poster so that the web server 70 can determine at any given time which posters in a particular poster gallery are more popular than others, meaning ones that are ordered by users 50 more than others. The process illustrated in the flow chart in FIG. 5 illustrates how the rank field in the poster data structure 82 is updated for each poster so that posters displayed according to “most popular” in the “Sort By” dropdown box 174 operates correctly.

As illustrated in FIG. 5, the process starts (block 200), and a decision is made as to whether it is time to rank the posters in the product database 74 (decision 202). The timer or wakeup feature is set so that the posters in the product database 74 are ranked periodically, for instance once per day. If it is not time to rank posters in the product database 74, the process continues by returning back to decision 202 until it is time to update the rank field for each of the posters in the poster data structure 82. Once it is time to update the rank field in the poster data structure 82 for each of the posters in decision 202, a current poster counter is initialized to point to the first poster data structure 82 (block 204). The system then determines if the number of days that the current poster has been on-site is less than fourteen days (decision 206). This decision is made by determining if the “date added” field within the poster data structure 82 for the current poster is a date that is more than fourteen days prior to the current date. If the poster has been on-site for less than fourteen days, there is not enough sales data to accurately determine the rank of the poster and the system bypasses the setting of the rank for that particular poster (block 208) thereby keeping its current ranking within the poster data structure 82. Each time a new poster in the poster data structure 82 is added to the databases 72, a rank is assigned manually, and it is this rank that will be maintained for a period of at least fourteen days.

If the current poster has been on-site more than fourteen days as determined in decision 206, the system sets the rank filed for the current poster in the poster data structure 82 in the product database 74 to a number based on a formula. The formula is set forth in block 208 and is indicated below.

$$RANK = \begin{matrix}[ NO . OF \\ UNIQUE \\ ORDERS \\ MADE FOR \\ POSTER ]\end{matrix} \times [ [ LOG ( \begin{matrix}DAYS POSTER \\ ON SITE\end{matrix} ) X - 0.6965 ] + 3.95 ]$$

Thereafter, the current poster counter is incremented so that the rank of the next poster in the product database 74 can be set (block 210), and the system determines if all posters have been re-ranked in the product database 74 (decision 212). If not, the system continues in a looping fashion by returning back to decision 206 until all posters are re-ranked in the product database 74. If all posters have been re-ranked in decision 212, the process returns back to decision 202 until it is time to re-rank the posters.

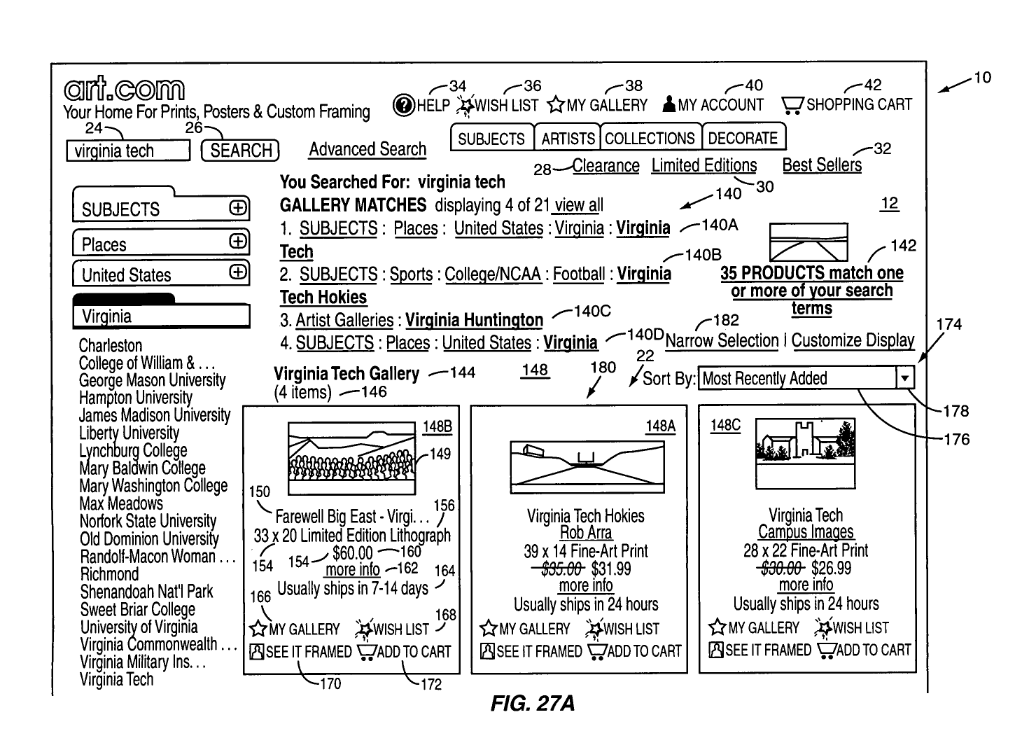

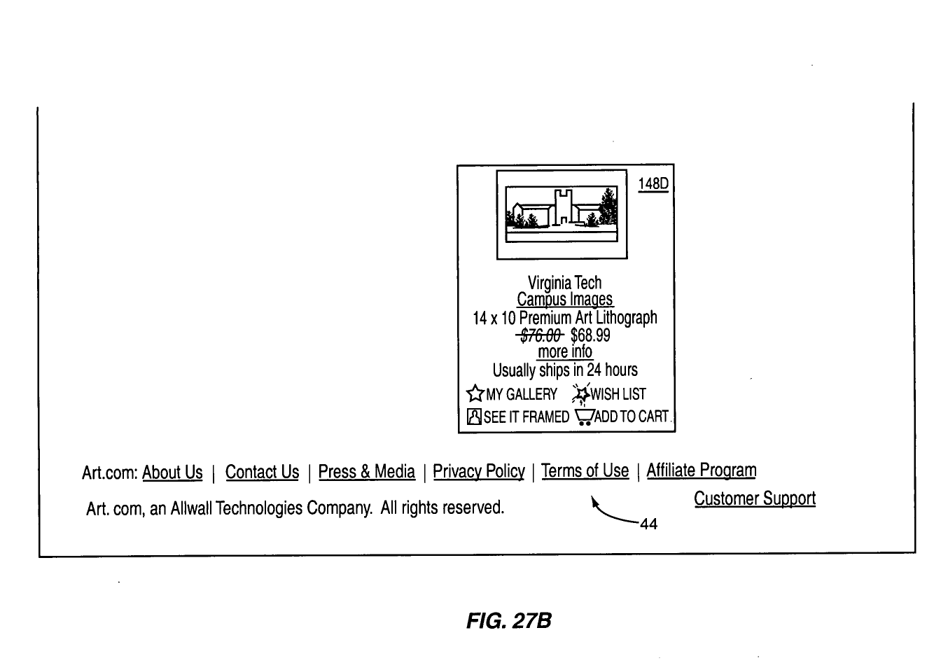

Starting at FIG. 6 and continuing to FIG. 27, each of the flow charts and web pages described illustrate each of the other sorting methods by which a user 50 can sort posters displayed in the poster display area 148. The user 50 selects these other sorting options by selecting different “Sort By” options in the “Sort By” dropdown box 174. These additional sorting techniques (described below) include displaying posters according to:
(1) Price (High to Low);
(2) Price (Low to High);
(3) Price (Highest Discounted Percentage);
(4) Size (Width, largest to smallest);
(5) Size (Width, smallest to largest);
(6) Size (Height, largest to smallest);
(7) Size (Height, smallest to largest);
(8) Size (Square, largest to smallest);
(9) Size (Square, smallest to largest);
(10) Product Availability; and
(11) Most Recently Added
   Price (High to Low)

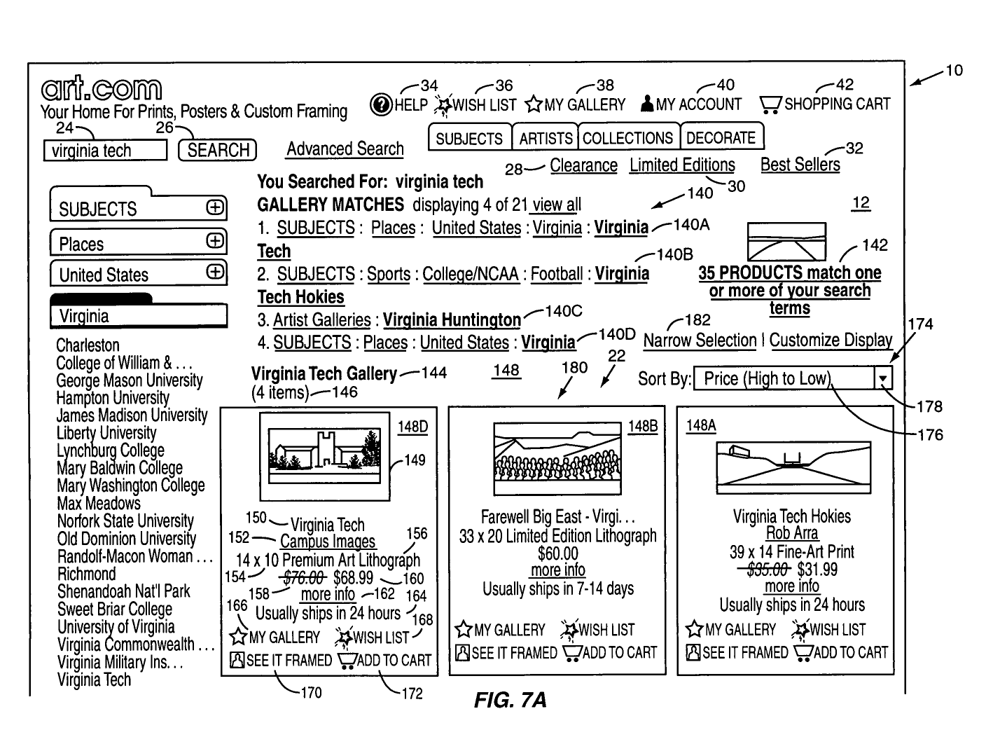

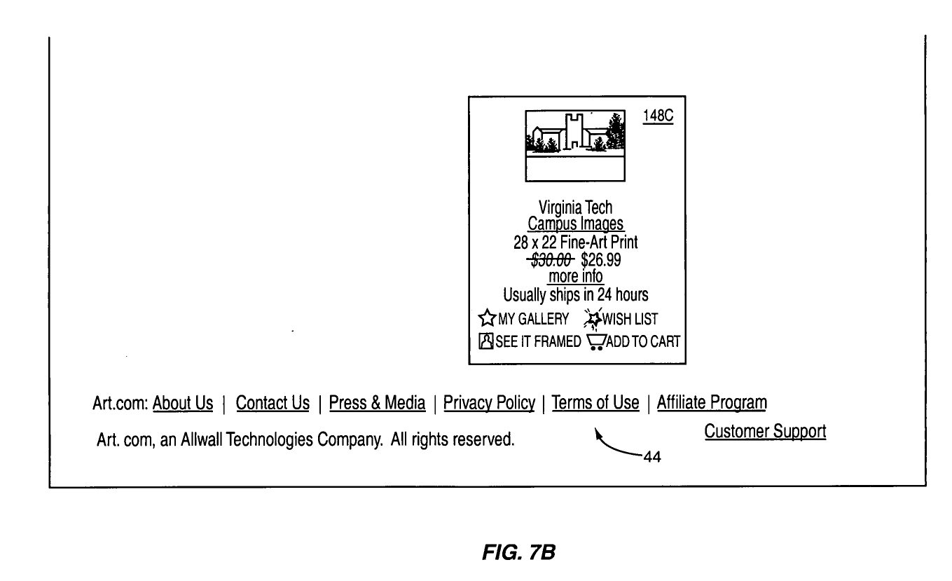

FIG. 6 illustrates a flow chart of the process of sorting posters in the poster display area 148 by those that have the highest retail price to the lowest retail price, called “Price (High to Low”). FIGS. 7A and 7B illustrate the web page 10 created and displayed on the user's browser 54 as the result of a sort request of the poster gallery 144 by “Price (High to Low”). This process is as follows.

The web server 70 receives a sort request for “Price (High to Low)” from the user's browser 54 (block 220). The user 50 makes this selection by selecting the “Price (High to Low)” option in the “Sort By” dropdown box 174 on the web page 10. The system then searches posters in the current gallery 144 to find the retail price field in the poster data structure 82 that is the highest of all posters not already selected for the sort result list 180 (block 222). The poster with the highest retail price is then saved in the sort result list 180 (block 224), and the system determines if all posters have been sorted in the current gallery 144 (decision 226). If not, the system continues in a looping fashion by returning to block 222 until all remaining posters have been sorted by their retail price to form a sort result list 180 of posters having the highest retail price to posters having the lowest retail price. Once all of the posters have been sorted in the current gallery 144 in decision 226, a web page 10 is created using the sort result list 180 so that the posters will be displayed in order of the highest retail price to lowest retail price in the poster display area 148 (block 228). The web page 10 with the updated list of posters from the highest retail price to lowest retail price in the poster display area 148 is sent to the user's browser 54 to be displayed in the form of a web page 10 (block 230), and the process ends (block 232).

FIGS. 7A and 7B illustrate the web page 10 created and sent to the user's browser 54 to be displayed as a result of the process in FIG. 6 whereby the user selected the “Price (High to Low)” in the “sort by” type 176 of the “sort by” dropdown box 174. The posters in the poster display area 148 are in order of the highest retail price to lowest retail price. Note that the first poster entitled “Campus Images” 148D having a retail price of $68.99 is displayed first, which is the highest retail price poster of the four posters in the Virginia Tech poster gallery 144. The last three posters are sorted from the highest to lowest retail price as well.

Price (Low to High)

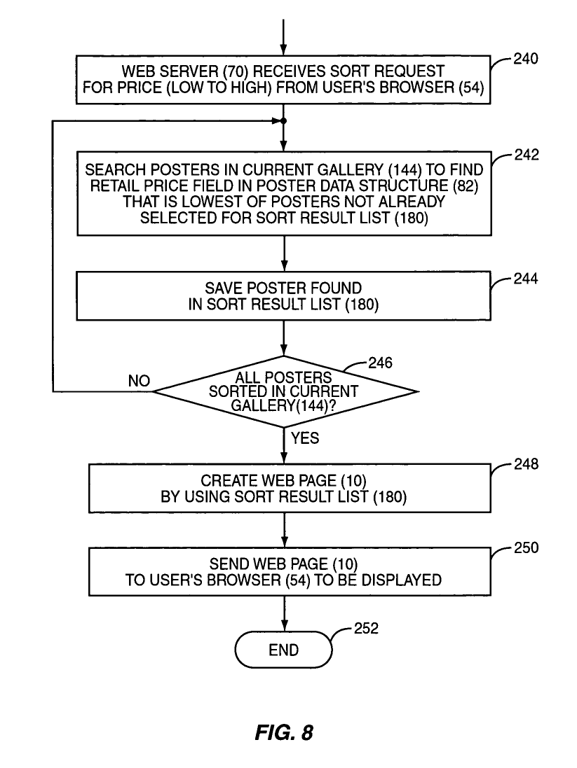

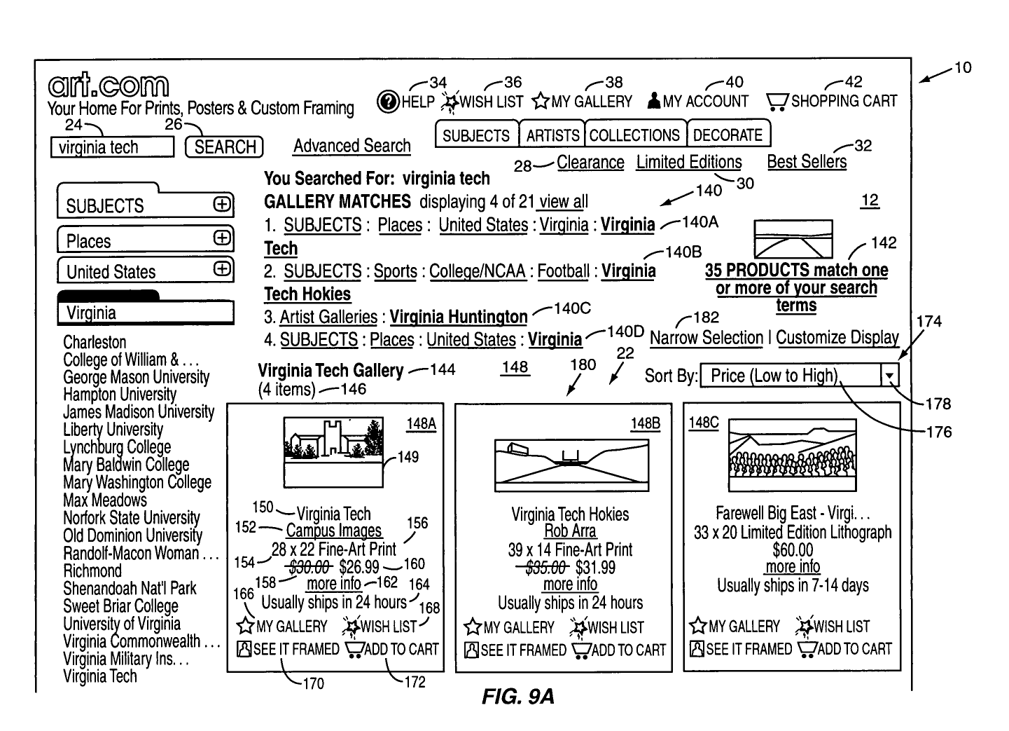

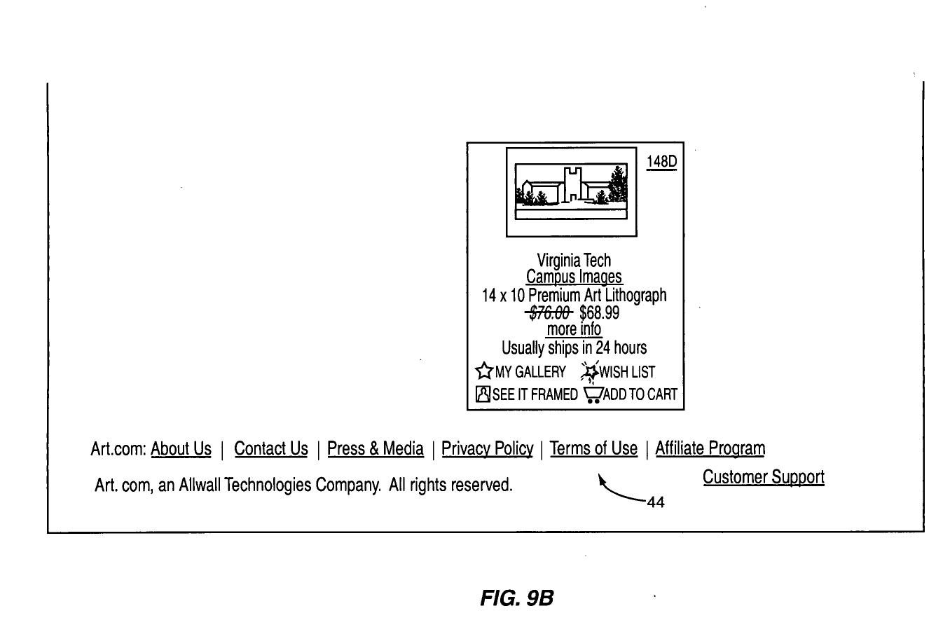

FIG. 8 illustrates a flow chart of the process of sorting posters in the poster display area 148 by those that have the lowest retail price to the highest retail price, called “Price (Low to High”), the opposite of “Price (High to Low”) in FIGS. 6, and 7A, 7B. FIGS. 9A and 9B illustrates the web page 10 created and displayed on the user's browser 54 as the result of a sort request of the poster gallery 144 by “Price (Low to High)”. This process is as follows.

The process starts on FIG. 8 by the web server 70 receiving a sort request for “Price (Low to High)” from the user's browser 54 (block 240). The system then searches for posters in the current gallery 144 to find the retail price field in the poster data structure 82 that is the lowest of all posters not already selected for the sort result list 180 (block 242). The poster with the lowest retail price is then saved in the sort result list 180 (block 244), and the system determines if all posters in the current gallery 144 have been sorted (decision 246). If not, the system continues in a looping fashion by returning to block 242 where the poster with the next lowest price is sorted to be added to the sort result list 180. Once all posters have been sorted based on the lowest retail price to the highest retail price in the current gallery 144 (decision 246), the system creates a web page 10 using the sort result list 180 (block 248). Thereafter, the web page 10 is sent to the user's browser 54 to be displayed such that the posters displayed in the poster display area 148 are ordered in terms of the poster with the lowest retail price being displayed first and the poster having the highest retail price being displayed last (block 250), and the process ends (block 252).

FIGS. 9A and 9B illustrate the web page 10 created and sent to the user's browser 54 to be displayed as a result of the process in FIG. 8 whereby the user selected the “Price (Low to High)” in the “sort by” type 176 of the “Sort By” dropdown box 174. The posters in the poster display area 148 are in order of lowest retail price to highest retail price. Note that the first poster displayed in poster display area 148A is a poster having a retail price of $26.99 in the retail price field 160. The last poster displayed in the poster display area 148D has a retail price of $68.99.

Price (Highest Discount Price)

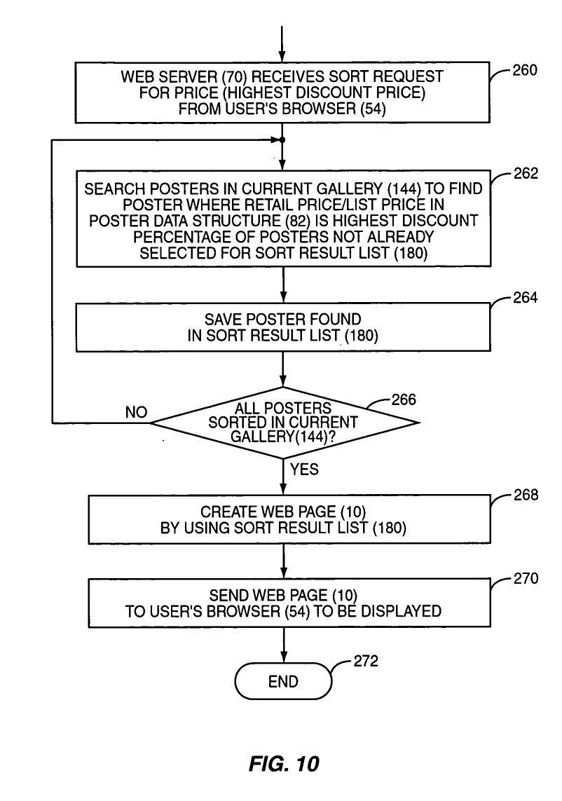

FIG. 10 illustrates a flow chart of the process wherein a user 50 selects the “Price (Highest Discount Price)” sort option in the “Sort By” dropdown box 174 to sort the posters in the current gallery 144 by those that have the highest discounted price to those having the lowest discounted price. The discount price percentage is the retail price 158 divided by the list price 160. The lower the list price 160 with respect to the retail price 158, the higher the percentage discount is of that poster.

As illustrated in FIG. 10, the web server 70 receives the sort request for “Price (Highest Discount Price)” from the user's browser 54 (block 260). The system thereafter sorts posters in the current gallery 144 to find posters where the retail price divided by the list price in the poster data structure 82 is the highest discount percentage of posters not already selected for the sort result list 180 (block 262). The poster having the highest discount percentage is then saved in the sort result list 180 (block 264). The system then determines if all posters in the current gallery 144 have been sorted (decision 266). If not, the process continues in a looping fashion by returning to block 262 where the poster with the next highest discount percentage of those not already selected for the sort result list 180 are found and added to the sort result list 180 (block 264). After all posters have been sorted in the current gallery 144 (decision 266), the system creates a web page 10 using the sort result list 180 (block 268), and the web page 10 is sent to the user's browser 54 to be displayed such that the posters displayed in the poster display area 148 are in the order of those having the highest discount percentage price to those having the lowest discount percentage price (block 270), and the process ends (block 272).

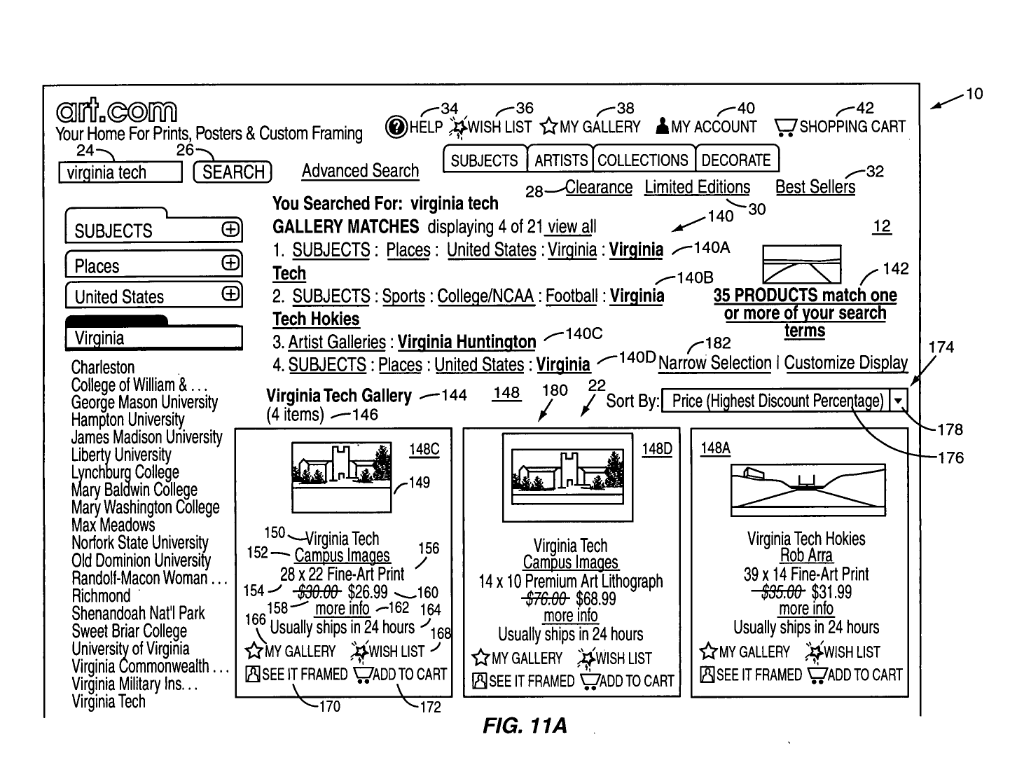

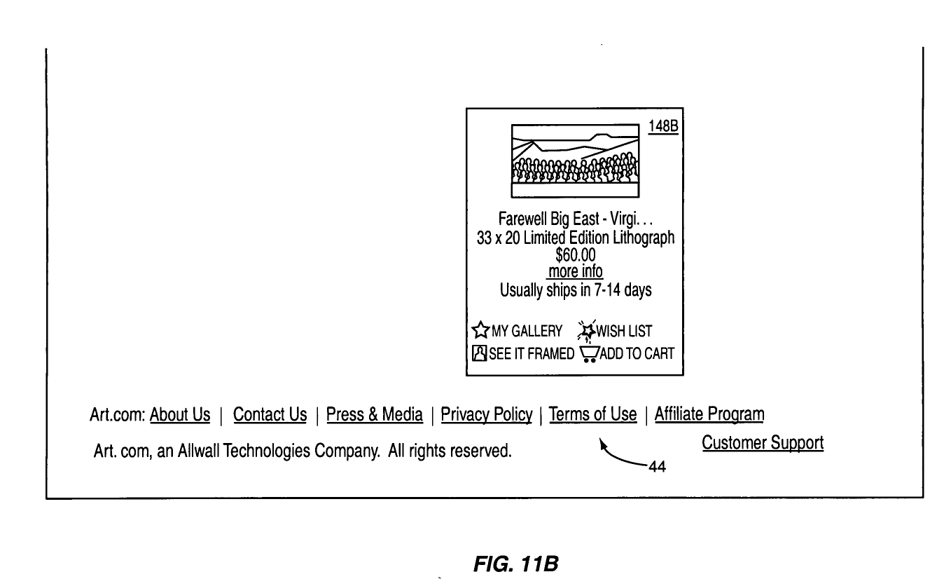

FIGS. 11A and 11B illustrate the web page 10 created and sent to the user's browser 54 to be displayed as a result of the process in FIG. 10 whereby the user selected the “Price (Highest Discount Percentage)” in the “sort by” type 176 of the “sort by” dropdown box 174. The first poster shown in FIG. 11 in the poster display area 148 is the “Campus Images” poster 148C which has a retail price of $30.00 and a list price of $26.99. That is an 11% discount, and is the highest discount percentage of all of the posters in the Virginia Tech gallery 144.

Size (Width, Largest to Smallest)

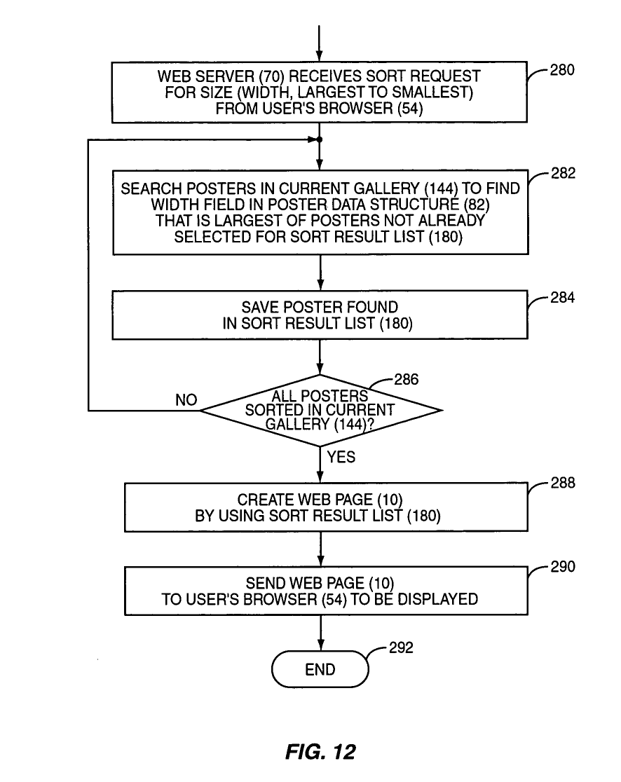

FIG. 12 illustrates the process where a user 50 has selected the “Size (Width, largest to smallest)” sort request in the “Sort By” dropdown box 174. This sort request causes the system to display posters in the current gallery 144 in order of those having the largest width first to those having the smallest width last. The web server 70 receives the sort request for “Size (Width, largest to smallest)” from the user browser 54 (block 280), and the system searches posters in the current gallery 144 to find the width field in the poster data structure 82 for a poster that is the largest of the posters not already selected for the sort result list 180 (block 282). The poster having the largest width is then saved in the sort result list 180 (block 284), and the system determines if all posters have been sorted in the current gallery 144 (decision 286). If not, the system continues in a looping fashion back to block 282 whereby posters are sorted to determine which poster not already selected for the sort result list 180 has the largest width. Once all posters have been sorted in the current gallery 144 from ones having the largest width to those having the smallest width in decision 286, the system creates a web page 10 using the sort result list 180 (block 288), and the web page 10 is sent to the user's browser 54 to be displayed (block 290), and the process ends (block 292).

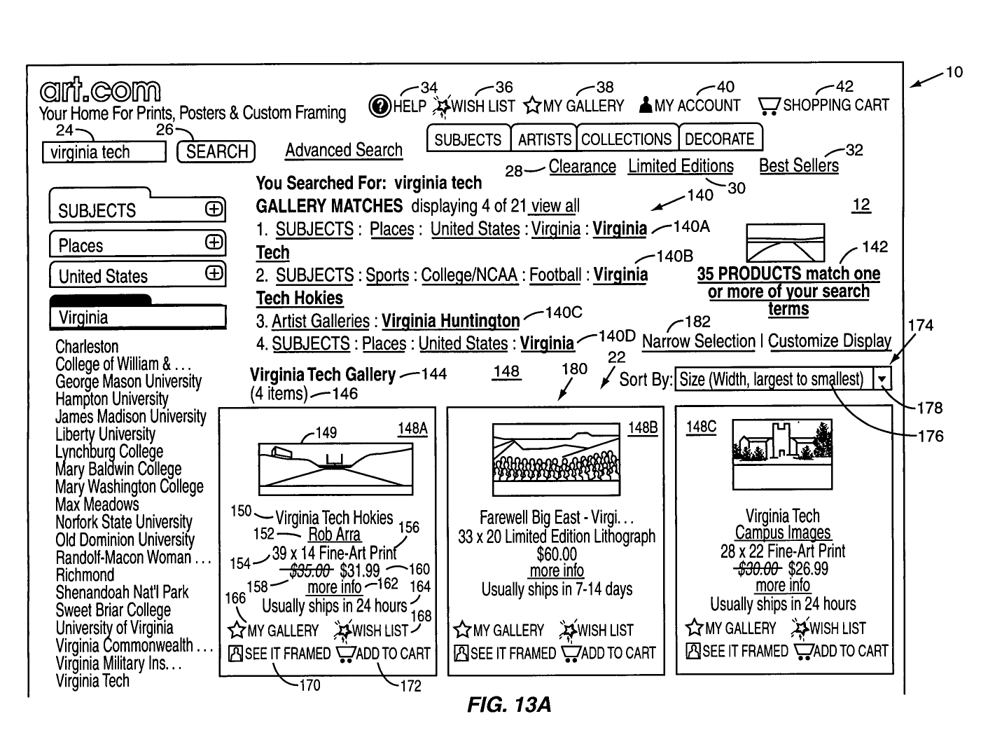

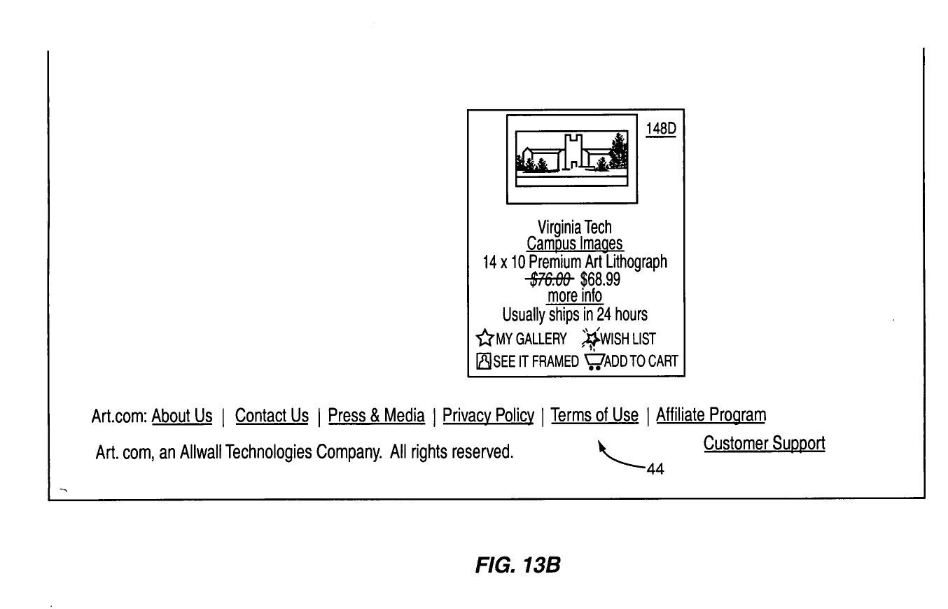

FIGS. 13A and 13B illustrate the web page 10 created and sent to the user's browser 54 to be displayed as a result of the process in FIG. 12 whereby the user selected the “Size (Width, largest to smallest)” in the “sort by” type 176 of the “sort by” dropdown box 174. The first poster 148A displayed in the poster display area 148A has a width of 39 inches, which is wider than any of the other posters in the Virginia Tech gallery 144. Therefore, this poster 148A is displayed first followed by subsequent posters having the next largest width until the poster having the smallest width 148D is displayed last.

Size (Width, Smallest to Largest)

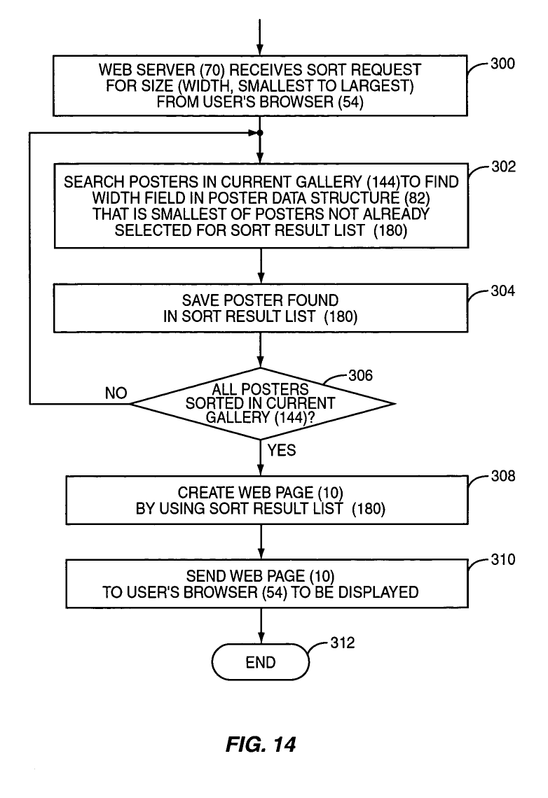

FIG. 14 illustrates the process where a user 50 has selected the “Size (Width, smallest to largest)” sort request in the “Sort By” dropdown box 174. This request causes posters in the poster display area 148 to be displayed in order of those having the smallest width first to those having the largest width last; the opposite of the sort request described for FIGS. 12, 13A and 13B above.

The process starts and the web server 70 receives the sort request for “Size (Width, smallest to largest)” from the user's browser 54 (block 300). The system then searches posters in the current gallery 144 to find the width field in the poster data structure 82 for a poster that is the smallest of the posters not already selected for the sort result list 180 (block 302). The resulting poster having the smallest width of those posters not already selected for the sort result list 180 is then saved in the sort result list 180 (block 304), and the system determines if all posters have been sorted in the current gallery 144 (decision 306). If not, the system continues in a looping fashion back to block 302 to continue to sort the posters not already selected for the sort result list 180 to find the next poster having the smallest width to then add to the sort result list 180 until all posters in the current gallery 144 have been sorted. Thereafter, the system creates a web page 10 using the sort result list 180 (block 308), and the web page 10 is sent to the user's browser 54 to be displayed (block 310), and the process ends (block 312).

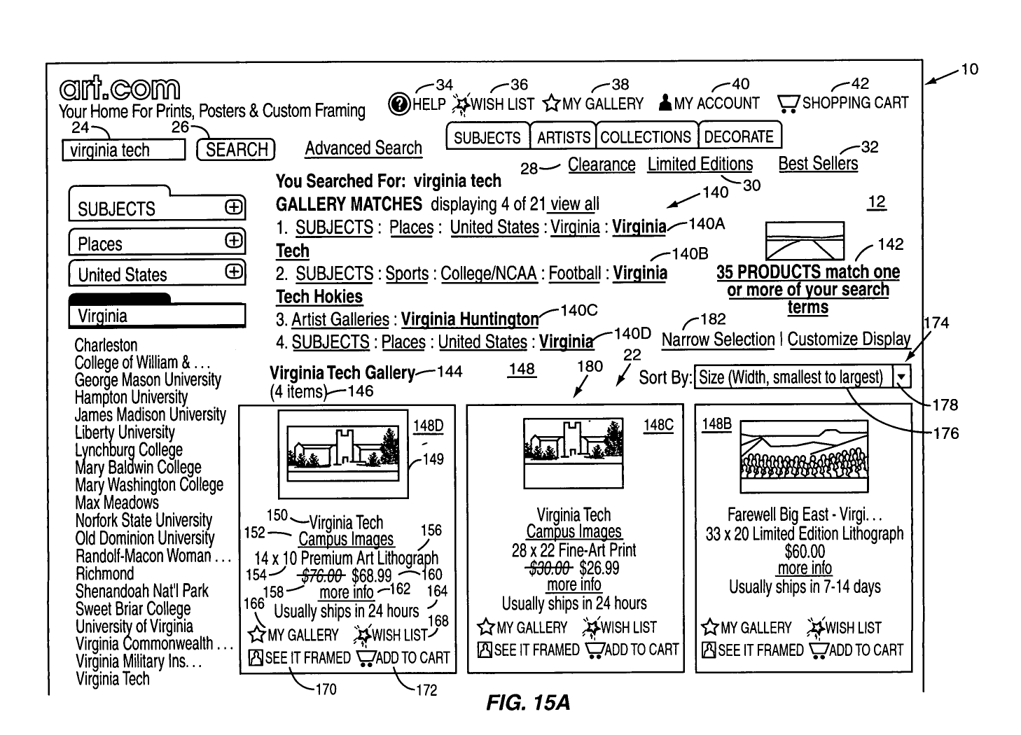

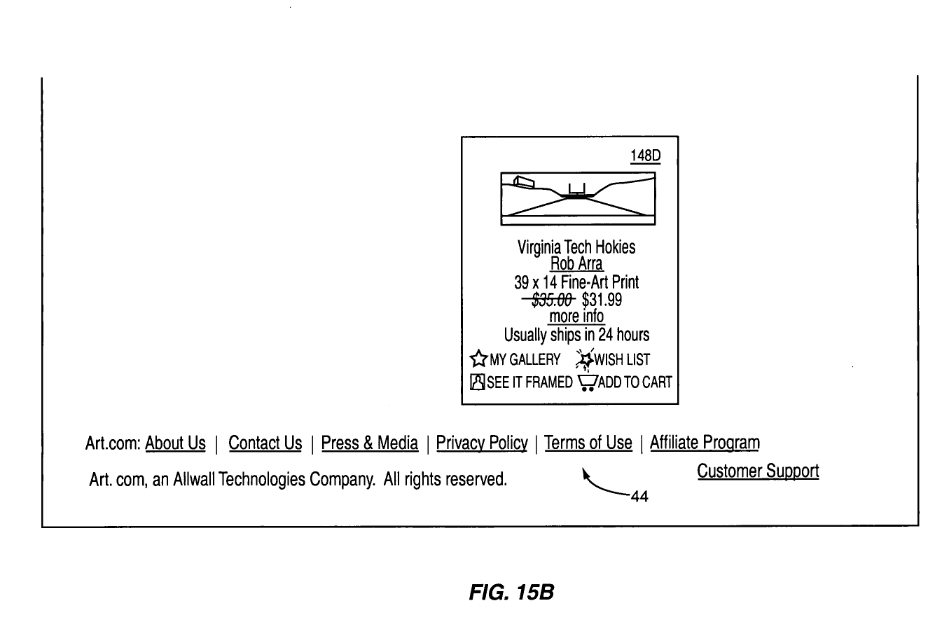

FIGS. 15A and 15B illustrate the web page 10 created and sent to the user's browser 54 to be displayed as a result of the process in FIG. 13. Note that as opposed to FIGS. 13A and 13B, poster 148D having a width of 14 inches is displayed first in the poster display area 148, and the poster 148A having the largest width of 39″ is displayed last in the poster display area 148.

Size (Height, Largest to Smallest

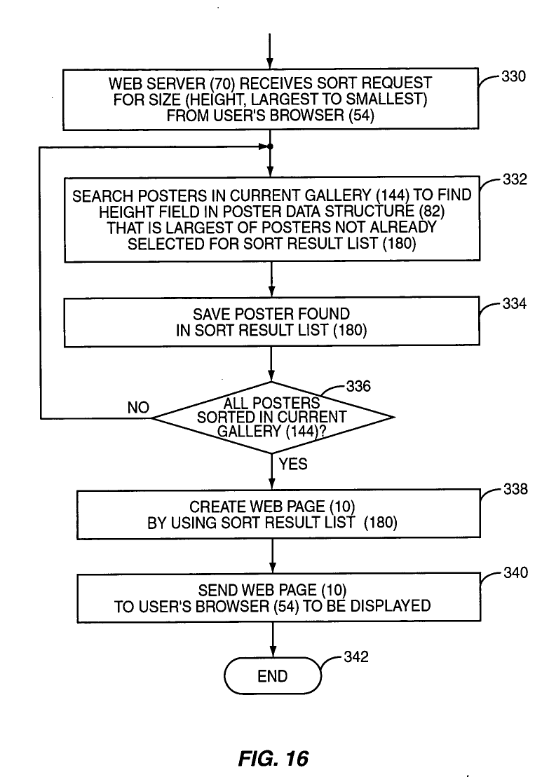

FIG. 16 illustrates the process where a user 50 has selected the “Size (Height, largest to smallest)” sort request in the “Sort By” dropdown box 174. The web server 70 receives a sort request for “Size (Height, largest to smallest)” from the user's browser 54 (block 330). The system then searches posters in the current gallery to find the height field in the poster data structure 82 for a poster that is the largest of the posters not already selected for the sort result list 180 (block 332). Thereafter, the poster having the largest height is saved in the sort result list 180 (block 334), and the system determines if all posters have been sorted in the current gallery (decision 336). If not, the system continues in a looping fashion back to block 332 until all posters in the current gallery have been sorted to form a result list 180 of those posters having the largest height to those having the smallest height. Once all posters have been sorted in the current gallery in decision 336, the system creates a web page 10 using the sort result list 180 (block 338), and the web page 10 is sent to the user's browser 54 to be displayed (block 340), and the process ends (block 342).

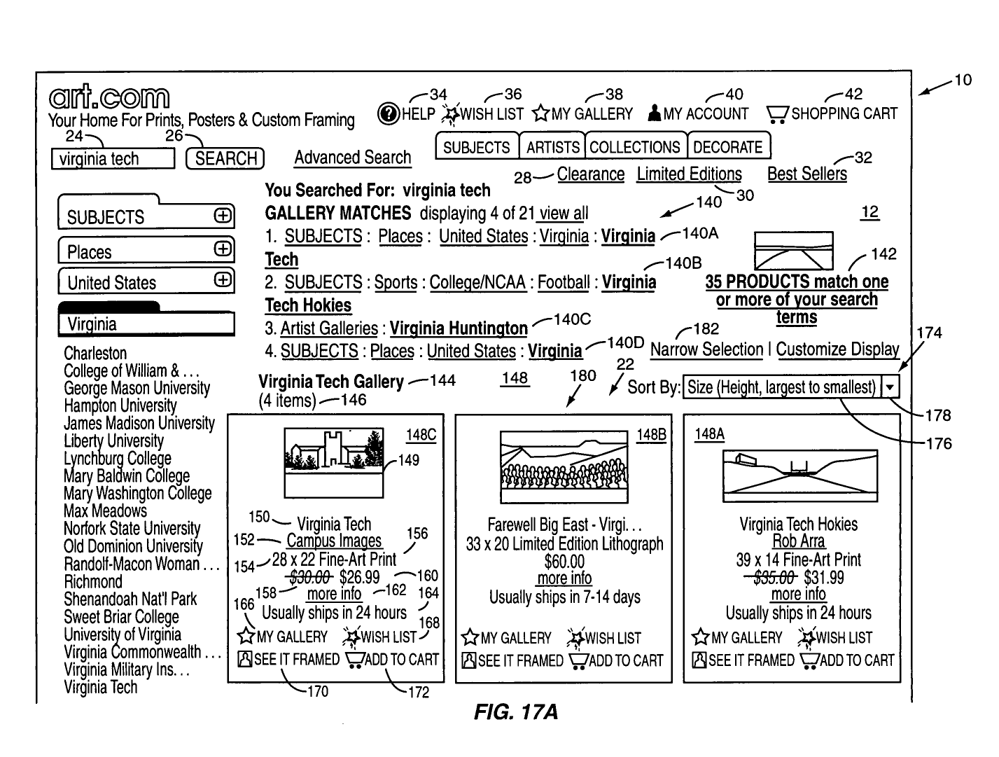

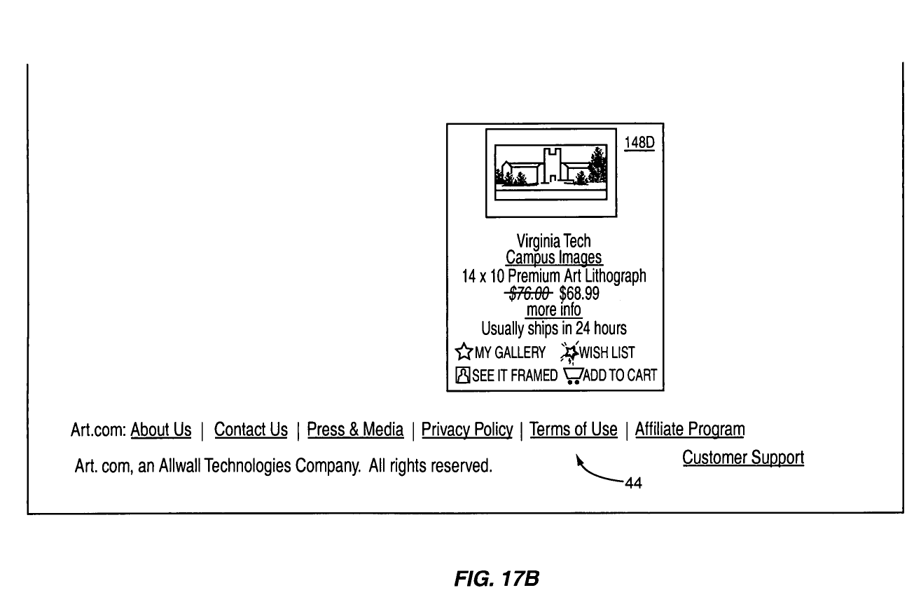

FIGS. 17A and 17B illustrate the web page 10 that is displayed on the user's browser 54 as a result of the process described in FIG. 15 whereby the user selected the “Size (Height, largest to smallest)” in the “sort by” type 176 of the “sort by” dropdown box 174. As illustrated in FIGS. 17A and 17B, the first poster 148C has a height of 22 inches and is the poster having the largest height of all of the posters in the Virginia Tech gallery 144. Posters having subsequently smaller height are displayed until the last poster 148D is displayed, which has a height of only 10 inches and is the smallest height of all of the posters in the Virginia Tech gallery 144.

Size (Height, Smallest to Largest)

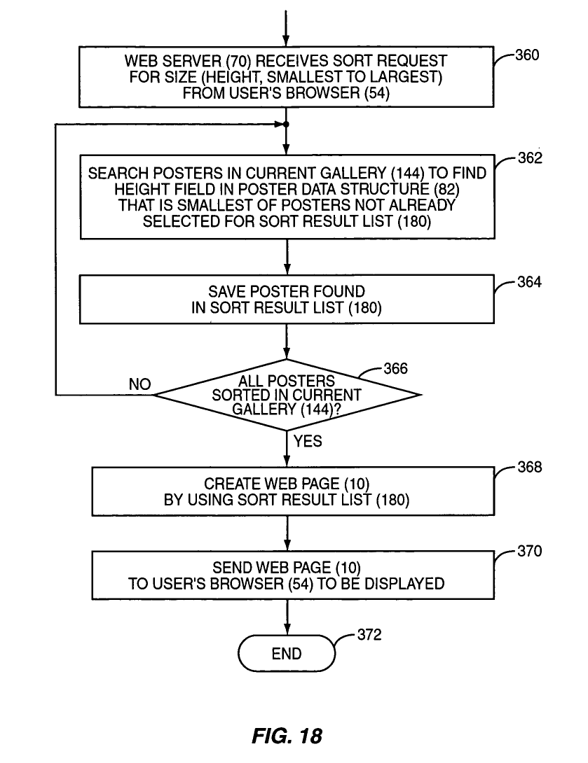

FIG. 18 illustrates the process where a user 50 has selected the “Size (Height, smallest to largest)” sort request in the “Sort By” dropdown box 174. The process starts by the web server 70 receiving a sort request for “Size (Height, smallest to largest)” from the user's browser 54 (block 360). Thereafter, the system searches posters in the current gallery 144 to find the height field in the poster data structure 82 for a poster that is the smallest of the posters not already selected for the sort result list 180 (block 362). The poster having the smallest height of those not previously selected for sort result list 180 are then saved in the sort result list 180 (block 364). The system then determines if all posters have been sorted in the current gallery 144 (decision 366). If not, the system continues in a looping fashion back to block 362 until all posters in the current gallery 144 have been sorted and added to the sort result list 180 in order of smallest height to largest height. Once all posters have been sorted in the current gallery 144 in decision 366, the system creates a web page 10 using the sort result list 180 (block 368), and the web page 10 is sent to the user's browser 54 to be displayed (block 370), and the process ends (block 372).

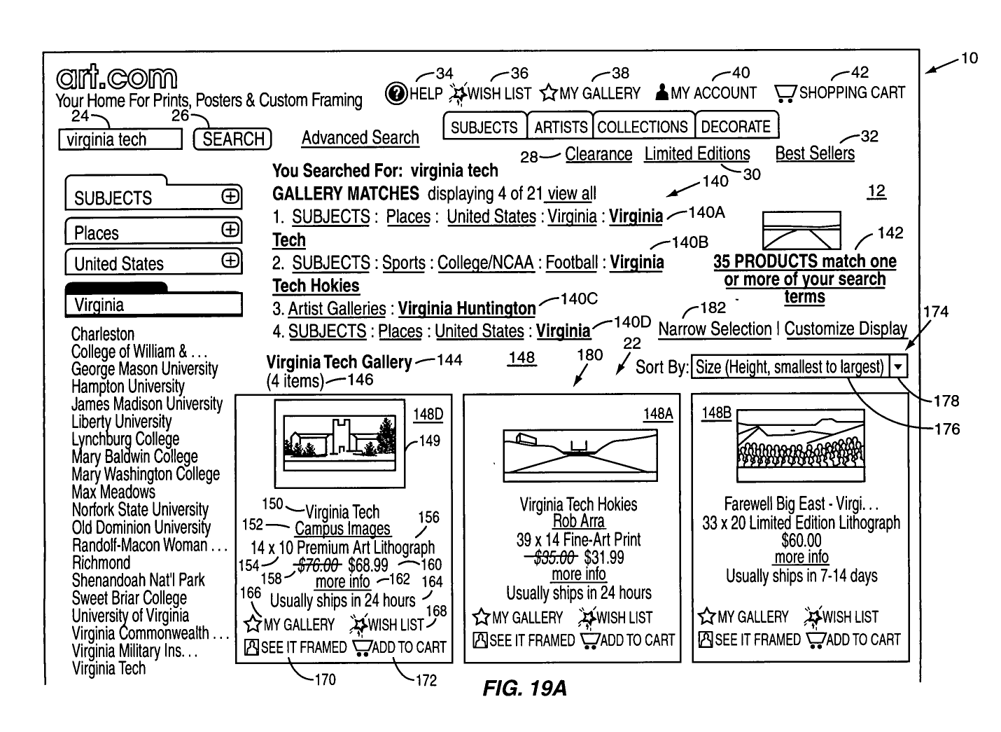

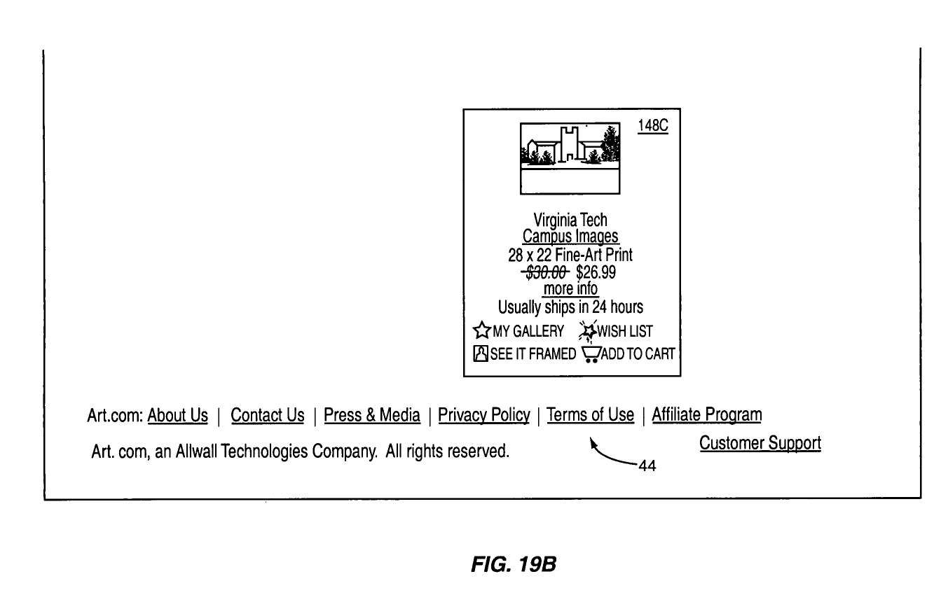

FIGS. 19A and 19B illustrate the web page 10 that is displayed on the user's browser 54 as a result of the process described in FIG. 18 whereby the user selected the “Size (Height, smallest to largest)” in the “sort by” type 176 of the “sort by” dropdown box 174. The poster 148D is displayed first in the poster display area 148, which has a height of 10 inches, the smallest of all of the posters in the Virginia Tech gallery 144. The other posters in the Virginia Tech gallery 144 are displayed in order of smallest height to largest height until the last poster 148C is displayed in the poster display area 148, which has a the largest height of 22 inches. The display order in the poster display area 148 illustrated in FIGS. 19A and 19B is the opposite of the order displayed in the poster display area 148 illustrated in FIGS. 17A and 17B.

Size (Square, Largest to Smallest)

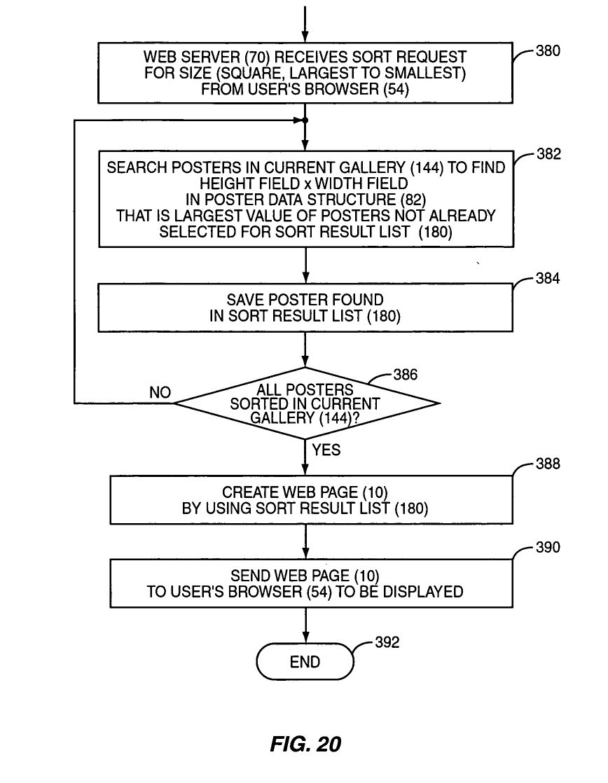

FIG. 20 illustrates the process whereby the user 50 requests a sort of posters in the current gallery 144 by those having the largest square area to those having the smallest square area. The process starts by the web server 70 receiving a sort request for “Size (Square, largest to smallest)” from the user's browser 54 (block 380). The system then searches posters in the current gallery 144 to find the posters in the poster data structure 82 having a square area (the height field times the width field) that is the largest value of the posters not already selected from the sort result list 180 (block 382). The poster having the largest square area of those not previously selected from sort result list 180 is then saved in the sort result list 180 (block 384). The system then determines if all posters have been sorted in the current gallery 144 (decision 386). If not, the system continues in a looping fashion back to block 382 until all posters in the current gallery 144 have been sorted based on square area and added to the sort result list 180. Once all posters have been sorted in the current gallery 144 in decision 386, the system creates a web page 10 using the sort result list 180 (block 388), and the web page 10 is sent to the user's browser 54 to be displayed (block 390), and the process ends (block 392).

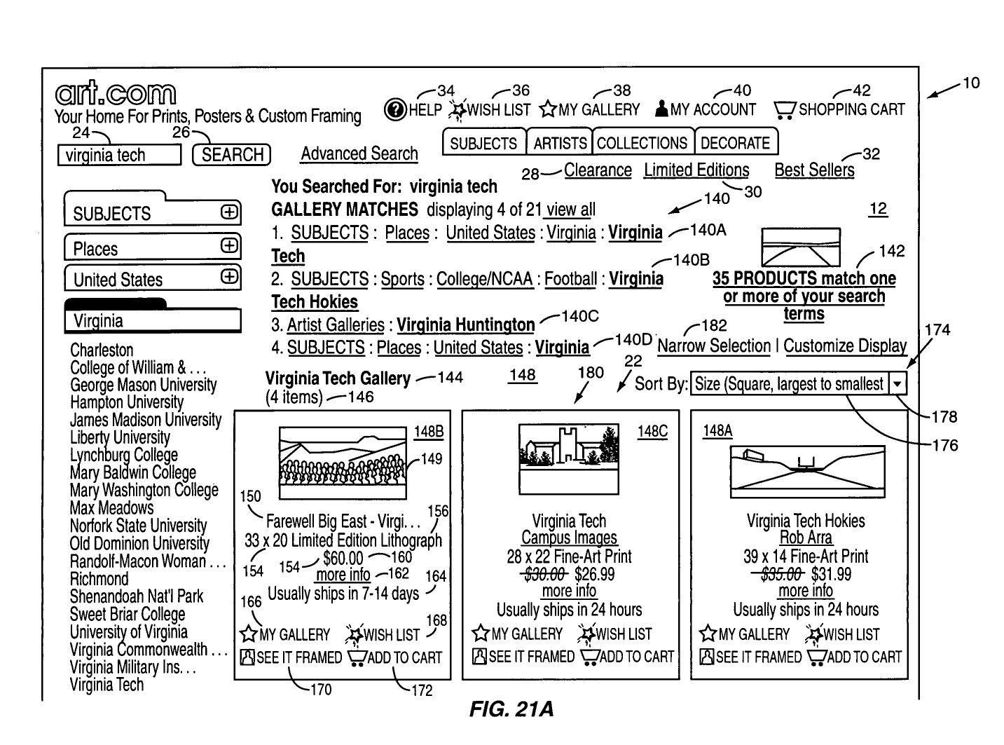

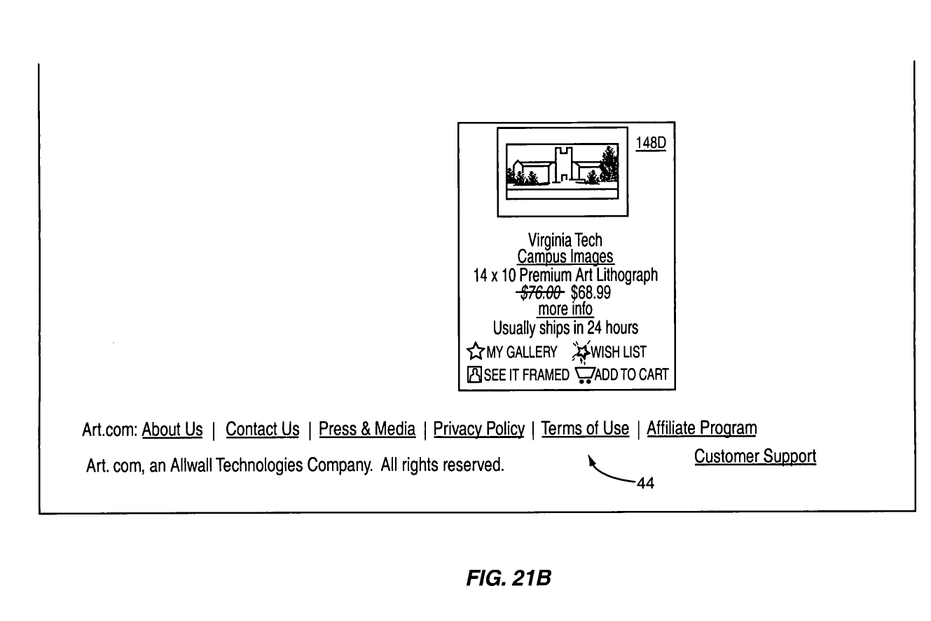

FIGS. 21A and 21B illustrate the web page 10 that is displayed on the user's browser 54 as a result of the process described in FIG. 20 whereby the user selected the “Size (Square, largest to smallest)” in the “sort by” type 176 of the “sort by” dropdown box 174. Poster 148B is displayed first in the poster display area 148, which has a square area of 660 square inches (33 inches by 20 inches). The other posters in the Virginia Tech gallery 144 are displayed in order of those having the largest square area to those having the least square area.

Size (Square, Smallest to Largest)

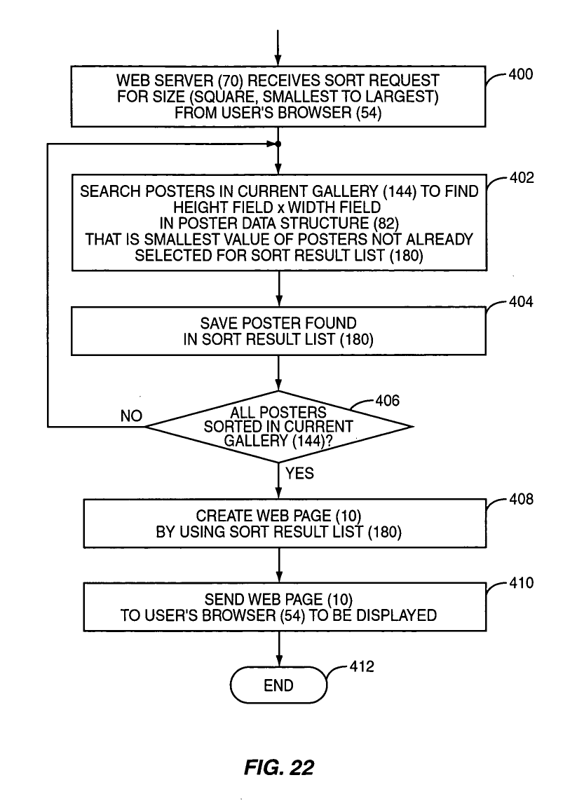

FIG. 22 illustrates the process whereby the posters in the poster display area 148 are sorted by those having the smallest square area to those having the largest square area, the opposite of the process illustrated in FIG. 20. The process starts by the web server 70 receiving a sort request for “Size (Square, smallest to largest)” from the user's browser 54 (block 400). The system then searches posters in the current gallery 144 to find the posters in the poster data structure 82 having a square area (the height field times the width field) that is the smallest value of the posters not already selected from the sort result list 180 (block 402). The poster having the smallest square area of those not previously selected for sort result list 180 is then saved in the sort result list 180 (block 404). The system then determines if all posters have been sorted in the current gallery 144 (decision 406). If not, the process continues in a looping fashion by returning to block 402 to continue sorting posters not already selected for sort result list 180 that have the next smallest square area. Once all posters have been sorted in the current gallery 144 as determined by decision 406, the system creates a web page 10 using the sort result list 180 (block 408), and the web page 10 is sent to the user's browser 54 to be displayed (block 410), and the process ends (block 412).

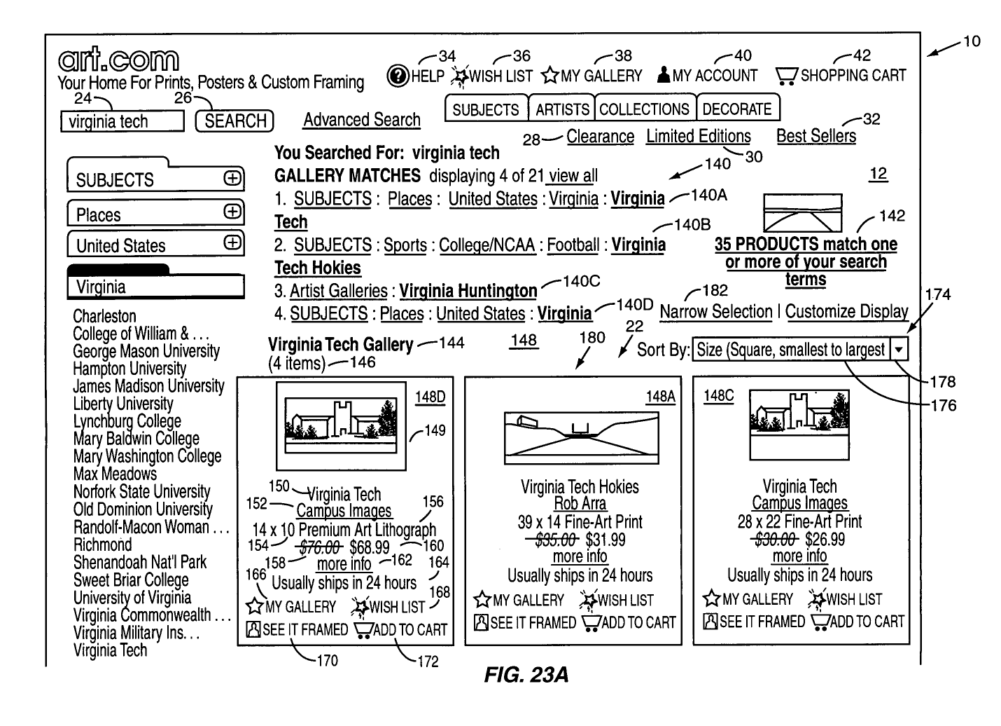

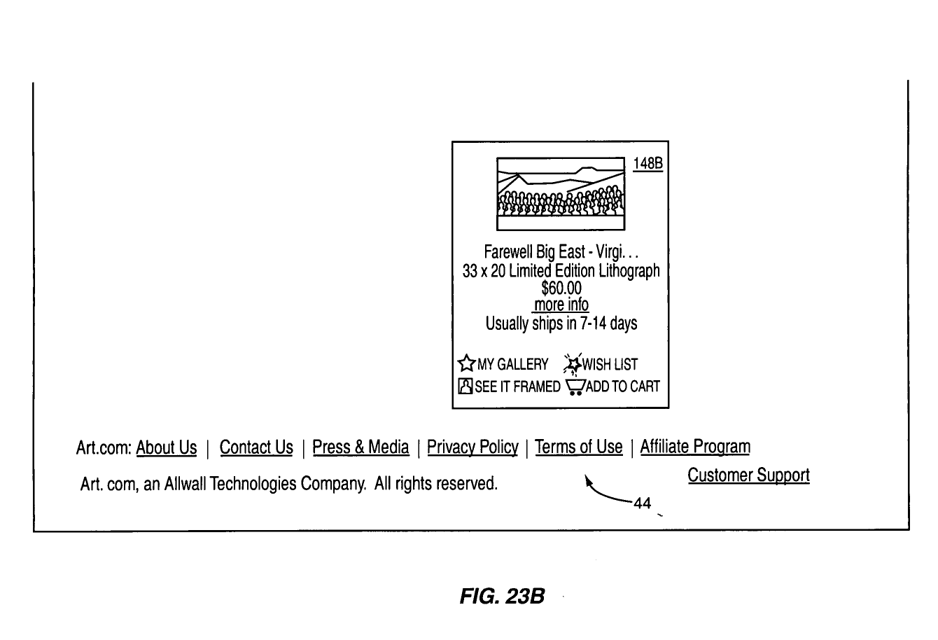

FIGS. 23A and 23B illustrate the web page 10 that is displayed on the user's browser 54 as a result of the process described in FIG. 22 whereby the user selected the “Size (Square, smallest to largest)” in the “sort by” type 176 of the “sort by” dropdown box 174. Poster 148D has the smallest square area of 140 square inches and is displayed first in the poster display area 148. The remaining posters in the Virginia Tech gallery 144 are displayed in order of those having the least square area ending with poster 148B which has the largest square area. The order of posters displayed in the poster display area 148 in FIGS. 23A and 23B is the exact opposite of the display order of posters in the poster display area 148 in FIGS. 21A and 21B.

Product Availability

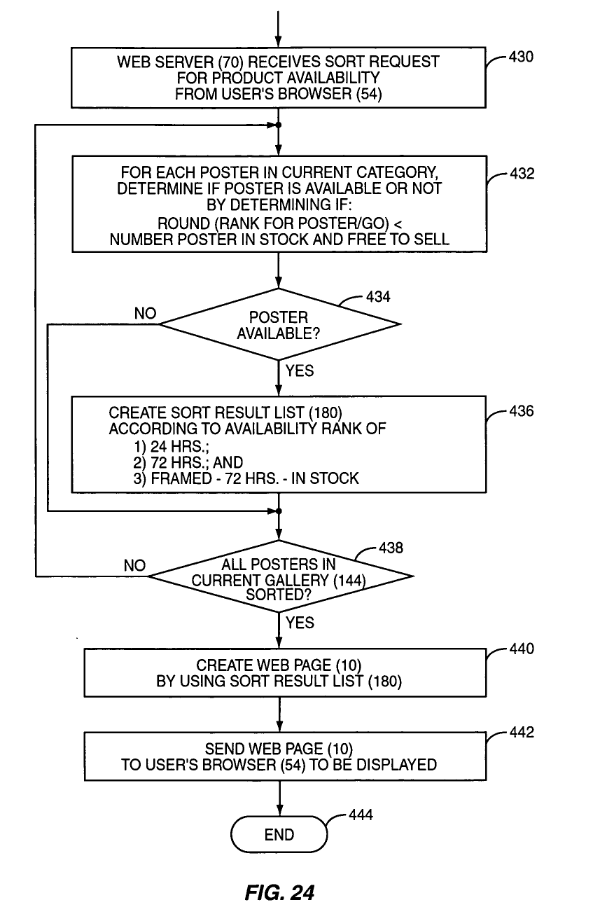

FIG. 24 illustrates the process whereby the user 50 selects a sort request of “Product Availability,” meaning that the user 50 wishes to display posters in the poster display area 148 in order of those most available to be shipped if selected for purchase to those least available. The process starts by the web server 70 receiving a sort request for “Product Availability” from the user's browser 54 (block 430). Then for each poster in the current gallery 144, the system determines if the poster is available or not by determining if the following equation is true (block 432).

Round (Rank for Poster/Number of Posters Forecasted Until Web Site Updated)<Number of Posters in Stock and Free to Sell

If the poster is available as determined by the formula above (decision 434), the system creates a sort result list 180 according to availability rank of posters being available within twenty-four hours first within the sort result list 180. Next, posters are sorted to those available within seventy-two hours, and lastly those available as being able to be framed within seventy-two hours as in stock (block 436). The system then determines if all posters in the current gallery 144 have been sorted (decision 438) and if not, the system returns to block 432 by subsequently determining if each remaining poster not already added to the sort result list 180 is available and if so, then adding such poster to the sort result list 180 according to the ranking in block 436. Once all of the posters in the current gallery 144 have been sorted according to availability as determined in decision 438, the system creates a web page 10 using the sort result list 180 (block 440), the web page 10 is sent to the user's browser 54 to be displayed (block 442), and the process ends (block 444).

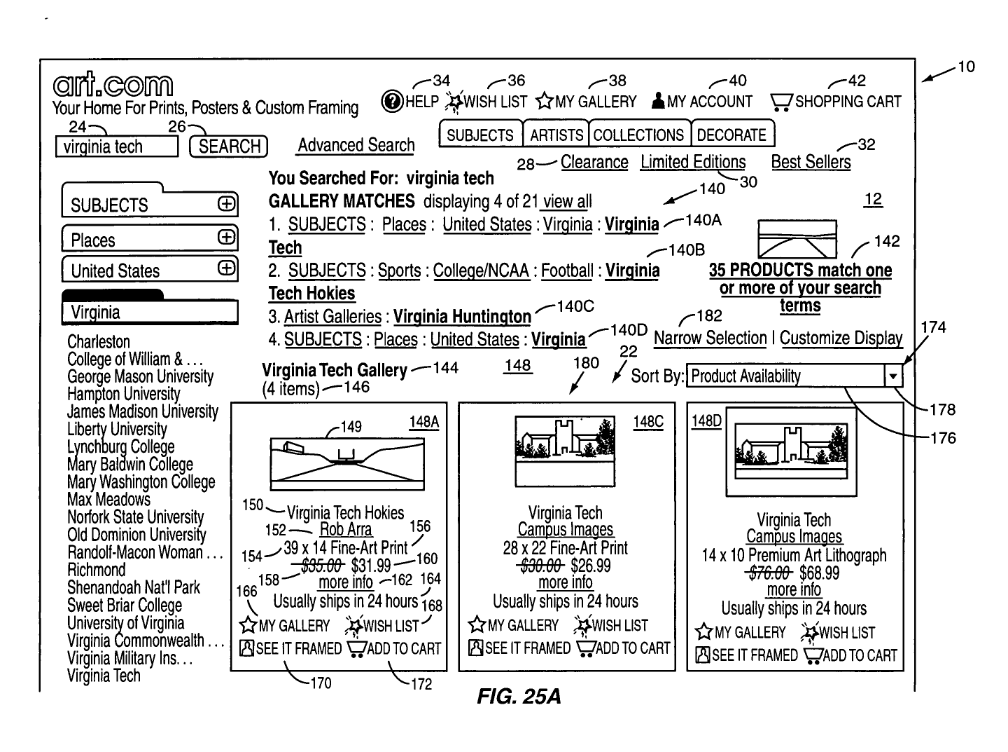

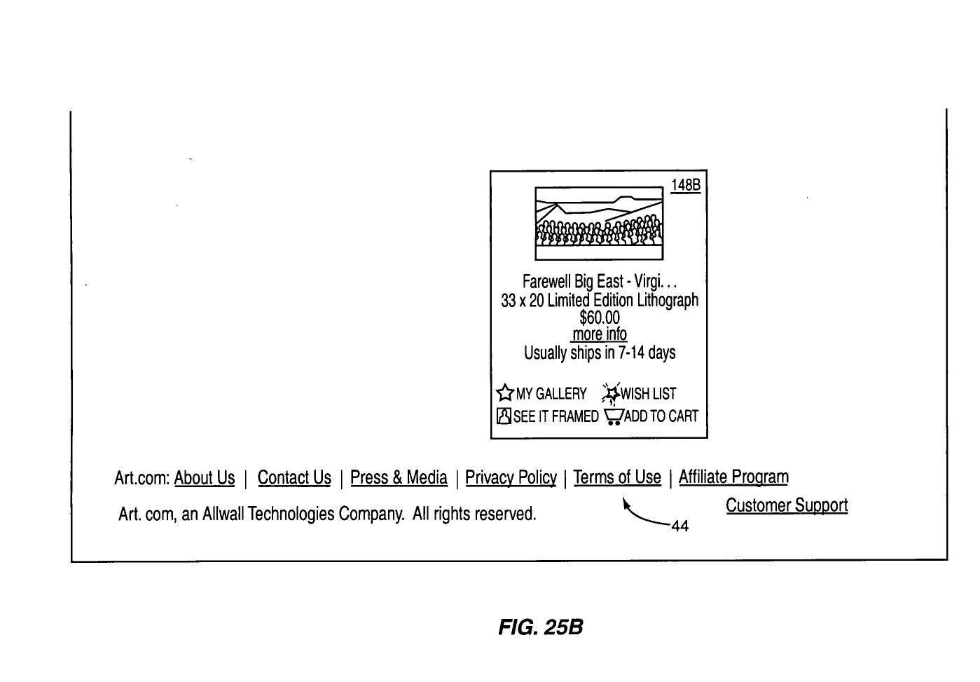

FIGS. 25A and 25B illustrate the web page 10 sent to the user's browser 54 in FIG. 24 whereby the user selected “Product Availability” in the “sort by” type 176 of the “sort by” dropdown box 174. The “product availability” sort request in “sort by” type 176 is displayed in the “sort by” dropdown box 174. The posters in the Virginia Tech gallery 144 are then displayed in the poster display area 148 in accordance with those most available to those least available. You will note that posters 148A, 148C and 148D in the poster display area 148 are listed as usually shipping within twenty-four hours in the shipment availability field, and the last poster 148B in the poster display area 148 is listed as usually shipping within seven to fourteen days.

Most Recently Added

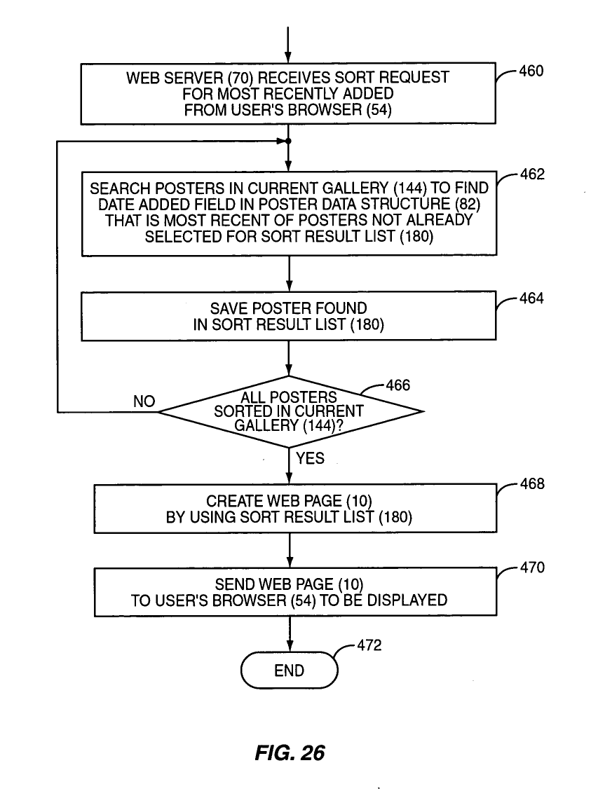

FIG. 26 illustrates the process of a sort request of posters “Most Recently Added” to the Art.com system. The process starts by the web server 70 receiving a sort request from the user's browser 54 for posters “Most Recently Added” (block 460). The system then searches the posters in the current gallery 144 to find the date added field in the poster data structure 82 that is the most recent of the posters not already selected for the sort result list 180 (block 462). Thereafter, the poster found that was most recently added of those posters not already selected for the sort result list 180 is saved in the sort result list 180 (block 464), and the system then determines if all posters in the current gallery 144 have been sorted (decision 466). If not, the system returns to block 462 in a repeating fashion until all posters are sorted according to their date added field in the poster data structure 82 to form the sort result list 180 of posters starting with those most recently added to those least recently added. Once all of the posters in the current gallery 144 have been sorted according to those most recently added as determined in decision 466, the system creates a web page 10 using the sort result list 180 (block 468), the web page 10 is sent to the user's browser 54 to be displayed (block 470), and the process ends (block 472).

FIGS. 27A and 27B illustrate the web page 10 sent to the user's browser 54 in FIG. 26 whereby the user selected “Most Recently Added” in the “sort by” type 176 of the “sort by” dropdown box 174. The posters in the Virginia Tech gallery 144 are then displayed in the poster display area 148 in the order of those most recently added to the Art.com system to those least recently added. The poster most recently added to the Virginia Tech gallery 144 in the Art.com system is poster 148B. The poster added to the Virginia Tech gallery 144 in the Art.com system before all of the other posters in the Virginia Tech gallery is poster 148D shown in the poster display area 148.

### Filtering Techniques

The user 50 is also able to filter posters in the current gallery 144 being displayed on the web page 10 so that only posters meeting certain defining criteria are displayed in the poster display area 148. Posters not meeting the filter criteria are not displayed on the web page 10. This is different than sorting posters, whereby all posters in the current gallery 144 are displayed in the poster display area 148; it is just the order of their display that is altered.

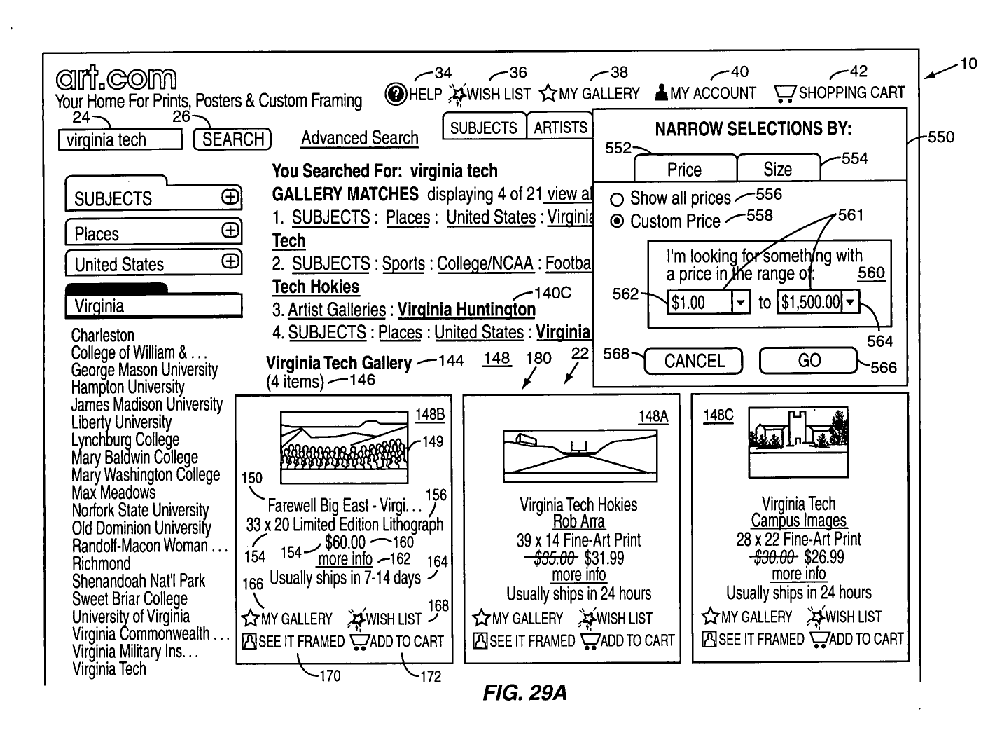

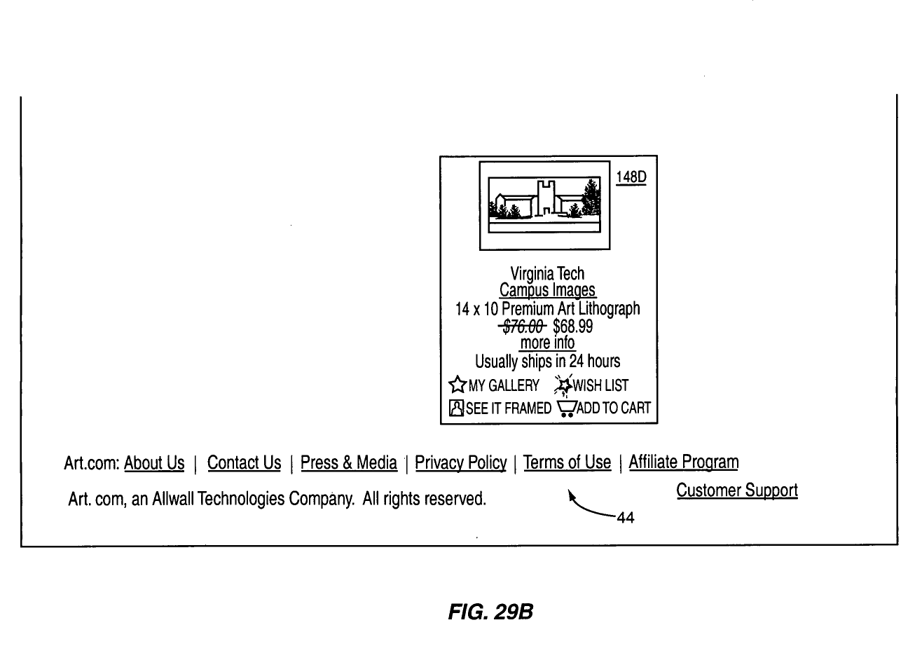

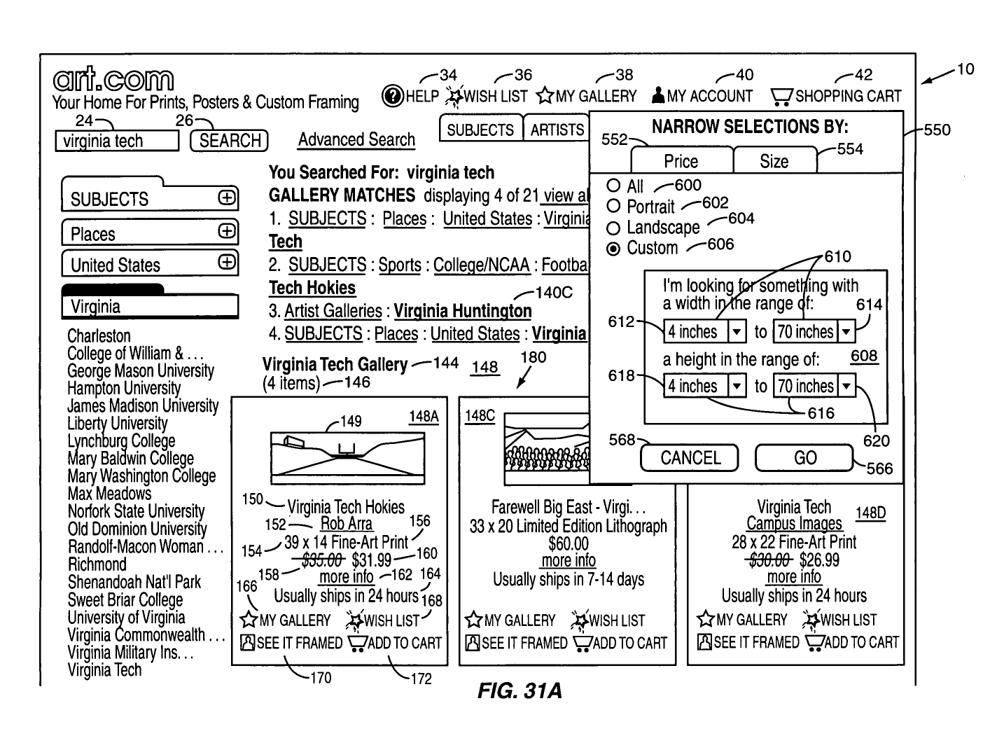

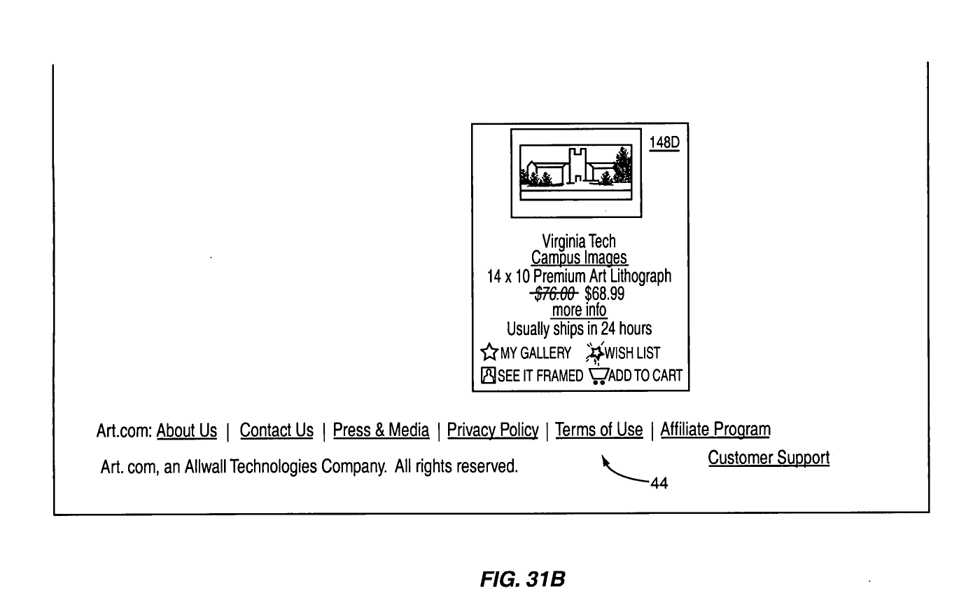

FIG. 28 illustrates a flow chart process whereby a user 50 can perform filtering of posters displayed in the poster display area 148 for a current poster gallery 144 in accordance with the present invention. The process starts by the user selecting the “narrow selection link” 182 on the web page 10, and this selection is sent from the user's browser 54 to the web server 70 (block 500). Thereafter, the web server 70 downloads a JAVA script file having a “.js” file extension with a narrow selection interface 550 to the user's browser 54 (block 502). The narrow selection interface 550 is illustrated in FIGS. 29A through 29B and FIGS. 31A through 31B. Before continuing with the description of the filtering aspects of the present invention in FIG. 28, a description of the narrow selection interface 550 illustrated in 29A through 29B and FIGS. 31A through 31B follow.

FIGS. 29A and 29B illustrate the narrow selection interface 550. The narrow selection interface 550 allows a user 50 to filter posters displayed in the poster display area 148 for the current poster gallery 144 based on either price, by selecting the “Price” filter tab 552, or by size, by selecting the “Size” filter tab 554. The narrow selection interface 550 defaults to the price filtering options the first time that the “narrow selection” link 182 is selected by the user 50. When filtering by price as shown in FIGS. 29A and 29B, the user 50 can choose to display all posters having all prices by selecting the “show all prices” button 556, or the user 50 can instruct the system to filter posters displayed in the poster display area 148 only if the posters have a retail price within a custom price range 561 by selecting the “Custom Price” filter button 558.

If the user 50 selects the “Custom Price” filter button 558, the user 50 can select a custom price range 561 by entering the low price range in the “low price range” dropdown box 562 and the high price range in the “high price range” dropdown box 564. Once the user 50 has set the custom price range 561, the user can select the “GO” button 566 to filter the posters displayed in the poster display area 148. The user 50 can also click the “CANCEL” button 568 to cancel the narrow selection interface 550 request.

If the user 50 selects the “Size” filter tab 554 as shown in FIGS. 31A and 31B, the user 50 can select to filter posters by size whereby only posters meeting the size filter criteria are displayed in the poster display area 148. The user selects the “Size” filter tab 554, and then selects either the “All” button 600, the “Portrait” filter button 602, the “Landscape” filter button 604, or the “Custom” button 606. If the user selects the “Custom” button 606, a custom size display 608 is displayed having a custom size width range 610 and a custom size height range 616. The user enters the size filter criteria in the form of the low width size 612, the high width size 614, the low height size 618, and the high height size 620. Once the user 50 has entered the custom size filter criteria in the custom size display 608, the user can select the “GO” button 566 to filter the posters displayed in the poster display area 148. The user 50 can also click the “CANCEL” button 568 to cancel the narrow selection interface 550 request.

FIGS. 31A and 31B illustrate the narrow selection interface 550 when filtering based on size is selected by the user 50. The user 50 filters the posters displayed in the poster display area 148 by selecting the “Size” filter tab 554. The user 50 can instruct the system to display posters having all sizes by selecting the “All” sizes filter button 600. The user can also direct the system to only display posters having a portrait configuration by selecting the “Portrait” filter button 602, or posters having a landscape configuration by selecting the “Landscape” filter button 604. The user 50 can also instruct the system to only display posters having a custom size by selecting the “Custom Size” filter button 606. If the user 50 selects the “Custom Size” filter button 606, a custom size display area 608 is displayed, and the user 50 can select a custom size width range 610 and a custom size height range 616 by entering the low width size 612 and a high width size 614, and a low height size 618 and a high width size 620. Thereafter, for the filtering selection by size to take effect, the user must select the “GO” button 566. Alternatively, the user 50 can click the “CANCEL” button 568 to cancel the narrow selection interface 550 request.

Now turning back to FIG. 28, after the web server 70 downloads the narrow selection interface 550 JAVA script file to the user's browser 54, the user 50 can make whatever narrow selections he or she desires in the narrow selection interface 550 to filter the posters displayed in the poster display area 148 of the web page 10. In the present invention, the narrow selection interface 550 is downloaded as a JAVA script file to the user's browser 54 so that when a user 50 selects the “narrow selection” link 182 a subsequent time during the same session, the narrow selection interface 550 does not have to be downloaded again by the web browser 54. This saves time and bandwidth. The flowchart in FIG. 28 illustrates the example whereby in block 504, the user 50 has selected the “narrow selection” link 182 a subsequent time during a session. Thereafter, the browser 54 displays a narrow selection interface 550 without making a subsequent request to the web server 70 since the JAVA script file for the narrow selection interface 550 has been previously downloaded.

Next, the user 50 enters the narrow selection criteria, as previously described above, based on size or price in the narrow selection interface 550 and selects the “GO” button 566 to initiate the filter request. Subsequently, the filtering criteria is displayed by the user's web browser 54 to the web server 70 (block 506), and the web server 70 stores the narrow selection criteria for the user 50 in the session database 76 (block 508). In this manner, the narrow selection criteria is retained for the user 50 for the user's entire session on the Art.com website. Subsequent searches or category requests for display of posters will cause the web server 70 to filter the displayed posters in the poster display area 148 automatically without the user 50 having to enter the narrow selection criteria at the narrow selection interface 550 again. The user can choose to modify the narrow selection criteria or remove the narrow selection criteria if they so desire, and if done, subsequent searches will use the most recent narrow selection criteria stored for the user, if any.

After the web server 70 receives the narrow selection criteria from the user's browser 54 in block 510, the web server 70 queries the search database 78 for all posters in the current poster category to apply the filtering criteria to the posters in the current poster category (block 512). The web server 70 then applies the filter stored for the user 50 in the session database 76 to the current poster category (block 514). The web server 70 then sends a web page 10 with the filtered results to the user's browser 54 to be displayed (block 518). Thereafter, if the user 50 selects another poster category on the web page 10 (block 520), the process repeats by the web server 70 querying the search database 78 for posters that meet the filter criteria so that only posters meeting the filter criteria are displayed in the poster display area 148 on the web page 10.

Price

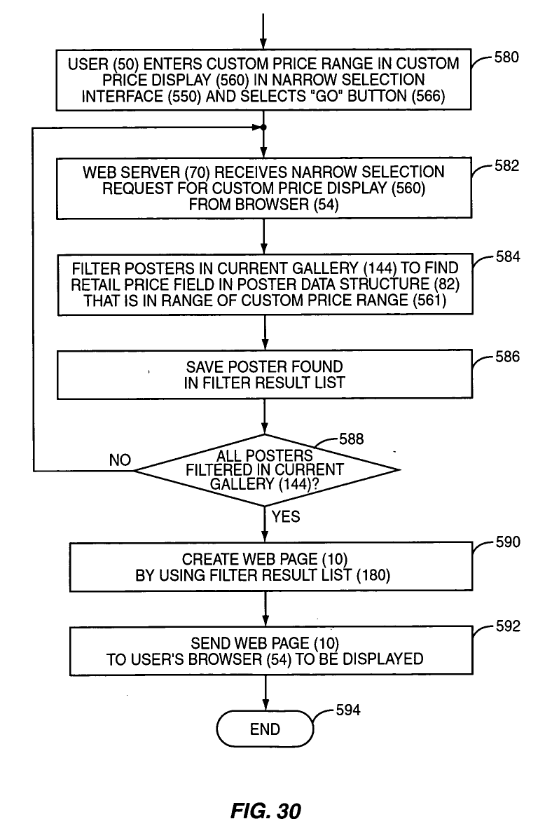

FIG. 30 illustrates a process whereby a user 50 can filter posters to be displayed in the poster display area 148 on a web page 10 based on the user 50 entering a customized price range 561 in the narrow selection interface 550. The process starts, and the user 50 enters a custom price range 561 in the custom price display 560 in the narrow selection interface 550 after selecting the price filter tab 552, and the user selects the “GO” button 566 (block 580). Next, the web server 70 receives the narrow selection request for the custom price display 560 from the user's browser 54 (block 582). The web server 70 filters the posters in the current gallery 144 to find the retail price in the poster data structure 82 for each of the posters in the current gallery 144 that is in range of the custom price range 561 (block 584). Thereafter, the system saves the posters falling within the custom price range 561 in the filter result list (block 586). The system then determines if all posters in the current gallery 144 have been filtered, meaning that it has been determined whether their retail price falls within a custom price range 561 (decision 588). If not, the process continues in a repeating fashion by the web server 70 reviewing the other posters in the current gallery to determine if their retail price falls within a custom price range 561 and to then add such posters to the filter result list. Once all posters have been filtered in the current gallery 144, the system creates a web page 10 by using the filter result list (block 590) and sends the web page 10 to the user's browser 54 to be displayed (block 592) and the process ends (block 594).

“Portrait” Size

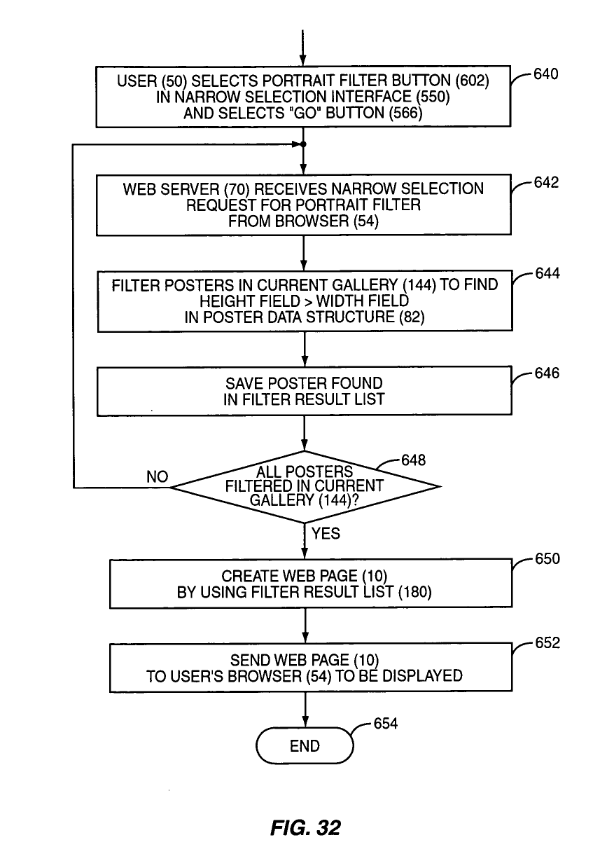

FIG. 32 illustrates a process whereby the user 50 can select to filter posters in the current gallery 144 based on their being in a “Portrait” layout. The user 50 can select a size filter by selecting the “Size” filter tab 554 and the portrait orientation by selecting the “Portrait” filter button 602, as previously discussed above and illustrated in FIGS. 31A and 31B. The process starts when the user 50 selects the “Portrait” filter button 602 in the narrow selection interface 550 and selects the “GO” button 566 (block 640). The web server 70 receives the narrow selection request for the portrait filter from the browser 54 (block 642). The system then filters posters in the current gallery 144 to find posters where the height field in the poster data structure 82 is greater than the width field in the poster data structure 82 (block 644). For each of these posters where the height field is greater than the width field, meaning that the posters are in a portrait-type format, such posters are saved in a filter result list (block 646). The system then determines if all posters in the current gallery 144 have been filtered to determine if they are in the portrait-type format (decision 648). If not, the process continues by repeating to block 642 whereby the web server 70 continues to go through each of the posters that have not been reviewed in the current gallery to determine if they are in the portrait-type format. Once all posters in the current gallery 144 have been reviewed to determine if they are in the portrait-type format as determined in decision 648, the system creates a web page 10 by using the filter result list (block 650) and sends the web page 10 to the user's browser 54 to be displayed (block 652) and the process ends (block 654).

“Landscape” Size

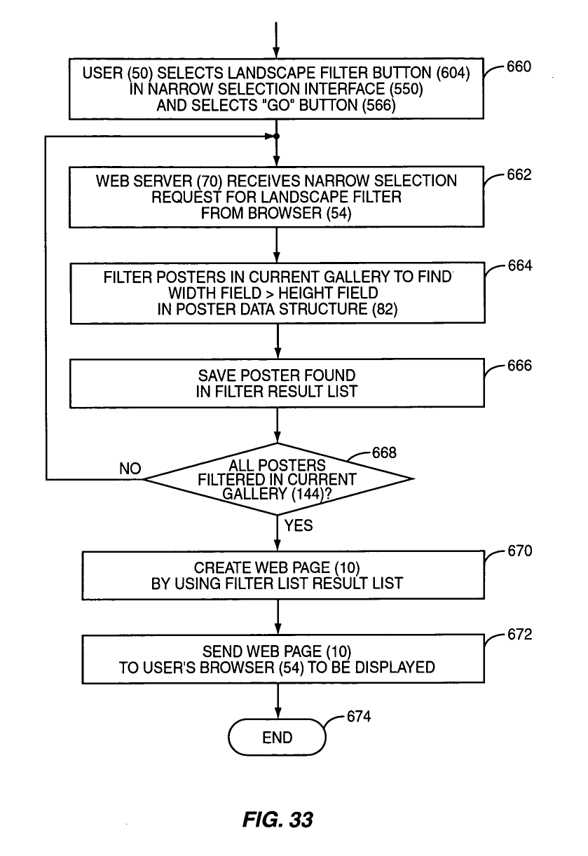

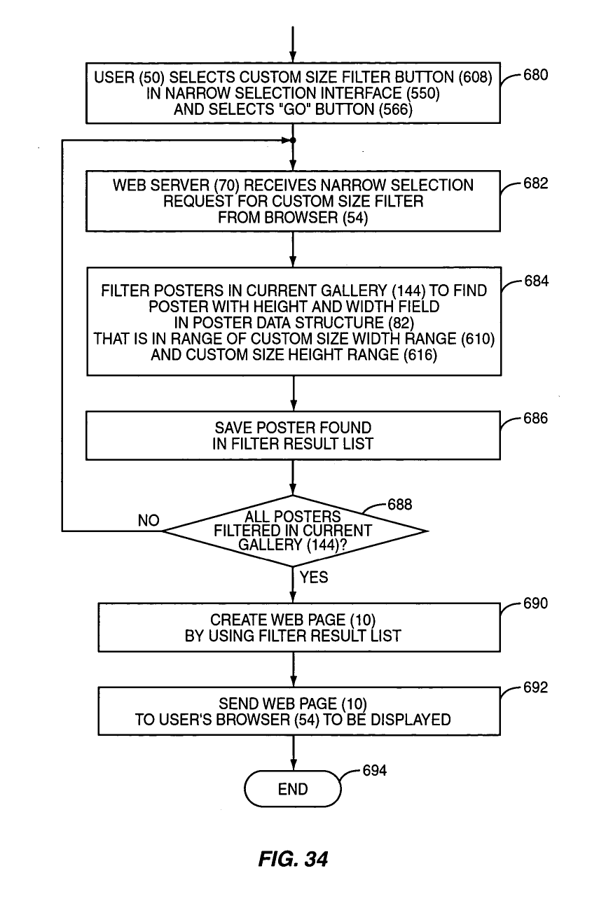

FIG. 33 illustrates a system whereby the user 50 can narrow or filter the posters displayed in the current gallery in the poster display area 148 to display posters based on their being in a landscape layout. The user 50 makes this request by selecting the size filter tab 554 within the narrow selection interface 550, selects the “Landscape” filter button 604 and selects the “GO” button 566 (block 660) as illustrated in FIGS. 31A and 31B. The web server 70 receives the narrow selection request for the landscape filter from the browser 54 (block 662). The system then filters posters in the current gallery 144 to find posters where the width field in the poster data structure 82 for a particular poster is greater than the height field in the poster data structure 82 (block 664). For each of these posters where the width field is greater than the height field, meaning that the posters are in a landscape format, such posters are saved in a filter result list (block 666). The system then determines if all posters in the current gallery 144 have been filtered to determine if they are in the landscape format (decision 668) and if not, the process continues by repeating to block 662 whereby the web server 70 continues to go through each of the posters that have not been reviewed in the current gallery 144 to determine if they are in the landscape format. Once all posters in the current gallery 144 have been reviewed to determine if they are in the landscape format as determined in decision 668, the system creates a web page 10 by using the filter result list (block 670) and sends the web page 10 to the user's browser 54 to be displayed (block 672) and the process ends (block 674).

“Custom” Size

Lastly, the user can select the poster display results 148 to only display posters within a custom size width range 610 and custom size height range 616. FIGS. 31A and 31B show how the user 50 can select the size filter tab 554 in the narrow selection interface 550 in the custom size filter button 606 to enter a low and high width size 612, 614 and a low and high height size 618, 620. The process starts when the user 50 selects the “Custom” size filter button 608 in the narrow selection interface 550 and selects the “GO” button 566 (block 680). The web server 70 receives the narrow selection request for the custom size filter from the browser 54 (block 682). The system then filters posters in the current gallery 144 to find posters with a height and width field in the poster data structure 82 that is in the range of the custom size width range 610 and the custom size height range 616 (block 684). Each poster in the current gallery 144 falling within the custom size width range 610 and the custom size height range 616 is then saved in a filter result list by the system (block 686). The system then determines if all posters in the current gallery 144 have been filtered to determine if they are in the custom size width range 610 and the custom size height range 616 (decision 688), and if not, the process continues by repeating to block 682 until all posters in the current gallery 144 have been checked to determine if they are within the custom size filter range selected by the user 50. Once all posters in the current gallery 144 have been reviewed to determine if they fall within the custom size filter range as determined in decision 688, the system creates a web page 10 by using the filter result list (block 690) and sends the web page 10 to the user's browser 54 to be displayed (block 692) and the process ends (block 694).

Please note that while the sizing and pricing filtering selections on the narrow selection interface 550 are discussed individually above, the user can select both sizing and pricing filter selections on the narrow selection interface 550 to be used in combination. The web server 70 will in turn use both restrictions to filter posters in the current gallery 144 and included on the web page 10 to be displayed on the user's browser 54.

Those skilled in the art will recognize improvements and modifications to the preferred embodiments of the present invention. All such improvements and modifications are considered within the scope of the concepts disclosed herein and the claims that follow.

1. A method of sorting artwork by size to be displayed on a browser coupled to the Internet, comprising the steps of:
creating a web page containing a list of artwork;
sending said web page containing said list of artwork over the Internet to the browser to be displayed on the browser;
receiving a sort request from the browser to sort said list of artwork by size; and
sorting said list of artwork to form an ordered list of artwork based on the size of said list of artwork.

2. The method of claim 1, further comprising creating a second web page containing said ordered list of artwork.

3. The method of claim 2, further comprising sending said second web page to the browser to be displayed on the browser.

4. The method of claim 1, wherein said step of sorting is comprised of sorting said list of artwork to form an ordered list of artwork in order of artwork from said list of artwork having the largest width to artwork from said list of artwork having the smallest width.

5. The method of claim 1, wherein said step of sorting is comprised of sorting said list of artwork to form an ordered list of artwork in order of artwork from said list of artwork having the smallest width to artwork from said list of artwork having the largest width.

6. The method of claim 1, wherein said step of sorting is comprised of sorting said list of artwork to form an ordered list of artwork in order of artwork from said list of artwork having the largest height to artwork from said list of artwork having the smallest height.

7. The method of claim 1, wherein said step of sorting is comprised of sorting said list of artwork to form an ordered list of artwork in order of artwork from said list of artwork having the smallest height to artwork from said list of artwork having the largest height.

8. The method of claim 1, wherein said step of sorting is comprised of sorting said list of artwork to form an ordered list of artwork in order of artwork from said list of artwork having the largest square area to artwork from said list of artwork having the smallest square area.

9. The method of claim 1, wherein said step of sorting is comprised of sorting said list of artwork to form an ordered list of artwork in order of artwork from said list of artwork having the smallest square area to artwork from said list of artwork having the largest square area.

10. The method of claim 1, further comprising filtering said ordered list of artwork based on size.

11. The method of claim 10, wherein said step of filtering is comprised of only including artwork having a portrait type size in said ordered list of artwork.

12. The method of claim 10, wherein said step of filtering is comprised of only including artwork having a landscape type size in said ordered list of artwork.

13. The method of claim 10, wherein said step of filtering is comprised of only including artwork within a custom size in said ordered list of artwork.

14. The method of claim 13, wherein said custom size includes a custom height range.

15. The method of claim 13, wherein said custom size includes a custom width range.

16. A system for sorting artwork by size to be displayed on a browser coupled to the Internet, comprising:
a web server communicatively coupled to the Internet; and
a database communicatively coupled to a database containing information about artwork;
said web server:
accesses said database to create a list of artwork;
creates a web page containing said list of artwork;
sends said web page containing said list of artwork to the browser;
receives a sort request from the browser to sort said list of artwork by size; and
sorts said list of artwork to form an ordered list of artwork based on the size of said list of artwork.

17. The system of claim 16, wherein said web server creates a second web page containing said ordered list of artwork.

18. The system of claim 17, wherein said web server sends said second web page to the browser to be displayed on the browser.

19. The system of claim 16, wherein said web server sorts said list of artwork to form an ordered list of artwork in order of artwork from said list of artwork having the largest width to artwork from said list of artwork having the smallest width.

20. The system of claim 16, wherein said web server sorts said list of artwork to form an ordered list of artwork in order of artwork from said list of artwork having the smallest width to artwork from said list of artwork having the largest width.

21. The system of claim 16, wherein said web server sorts said list of artwork to form an ordered list of artwork in order of artwork from said list of artwork having the largest height to artwork from said list of artwork having the smallest height.

22. The system of claim 16, wherein said web server sorts said list of artwork to form an ordered list of artwork in order of artwork from said list of artwork having the smallest height to artwork from said list of artwork having the largest height.

23. The system of claim 16, wherein said web server sorts said list of artwork to form an ordered list of artwork in order of artwork from said list of artwork having the largest square area to artwork from said list of artwork having the smallest square area.

24. The system of claim 16, wherein said web server sorts said list of artwork to form an ordered list of artwork in order of artwork from said list of artwork having the smallest square area to artwork from said list of artwork having the largest square area.

25. The system of claim 16, wherein said web server filters said ordered list of artwork based on size.

26. The system of claim 25, wherein said web server filters said ordered list of artwork by only including artwork having a portrait type size in said ordered list of artwork.

27. The system of claim 25, wherein said web server filters said ordered list of artwork by only including artwork having a landscape type size in said ordered list of artwork.

28. The system of claim 25, wherein said web server filters said ordered list of artwork by only including artwork within a custom size in said ordered list of artwork.

29. The system of claim 28, wherein said custom size includes a custom height range.

30. The method of claim 28, wherein said custom size includes a custom width range.

31. A method of sorting products displayed on a browser based on which products are most popular, comprising the steps of:
assigning a rank in a product database containing information about products wherein said rank is based on the numbers of orders for said product;
repeating said step of assigning until all products in said product database are assigned a rank;
receiving a request from the browser to retrieve a list of certain products out of said products; and
sorting said list of products based on said rank of said list of products certain to form an ordered list of products in order of highest rank to lowest rank.

32. The method of claim 31, further comprising creating a web page containing said ordered list of products.

33. The method of claim 32, further comprising sending said web page to the browser to be displayed on the browser.

34. The method of claim 32, wherein said step of assigning a rank is based on the number of unique orders for said product.

35. The method of claim 34, wherein said step of assigning a rank is further comprise of multiplying said number of unique orders for said product by a logarithmic function based on the number of days that said product has been available.

36. A system for sorting products based on which products are most popular to be displayed on a browser coupled to the Internet, comprising:
a web server communicatively coupled to the Internet; and
a database communicatively coupled to a database containing information about products;
said web server:
assigns a rank to each of said products wherein said rank is based on the numbers of orders for said products;
receives a request from the browser to retrieve a list of certain products out of said products; and
sorts said list of products based on said rank of said list of products certain to form an ordered list of products in order of highest rank to lowest rank.

37. The system of claim 36, wherein said web server creates a web page containing said ordered list of products.

38. The system of claim 37, wherein said web server sends said web page to the browser to be displayed on the browser.

39. The system of claim 37, wherein said rank is based on the number of unique orders for said product.

40. The system of claim 39, wherein said rank is calculated by multiplying said number of unique orders for said product by a logarithmic function based on the number of days that said product has been available.

41. A method of sorting products displayed on a browser based on the availability of the products, comprising the steps of:
receiving a request from the browser to sort a list of products based on the availability of said list of products;
determining if a product in said list of products is available and if said product is available in said step of determining, then:
creating a first sorted list of products based on products in said list of products being available in a first time frame;
creating a second sorted list of products based on products in said list of products being available in a second time frame different from said first time frame; and
creating an ordered list of products to be sent to the browser based on said first sorted list being included first in said ordered list of products and said second sorted list of products being included last in said ordered list of products.

42. The method of claim 41, further comprising creating a web page containing said ordered list of products.

43. The method of claim 42, further comprising sending said web page to the browser to be displayed on the browser.

44. The method of claim 41, wherein said first time frame is twenty-four hours, and said second time frame is greater than twenty-four hours.

45. The method of claim 41, wherein said products are artwork and said list of products are a list of artwork, and said step of determining is comprised of:
creating a first sorted list of artwork based on artwork in said list of artwork being available in a first time frame;
creating a second sorted list of artwork based on artwork in said list of artwork being available in a second time frame different from said first time frame;
creating a third sorted list of artwork based on artwork in said list of artwork being available for framing within a third time frame; and
creating an ordered list of artwork to be sent to the browser based on said first sorted list being included first in said ordered list of artwork and said second and third sorted list of artwork being included after said first sorted list in said ordered list of artwork.

46. The method of claim 44, wherein said second sorted list is included in said ordered list of artwork before said third sorted list.

47. A system for sorting products based on the availability of products to be displayed on a browser coupled to the Internet, comprising:
a web server communicatively coupled to the Internet; and
a database communicatively coupled to a database containing information about products;
said web server:
receives a request from the browser to sort a list of products based on the availability of said list of products;
determines if a product in said list of products is available and if said product is available, then:
creates a first sorted list of products based on products in said list of products being available in a first time frame;
creates a second sorted list of products based on products in said list of products being available in a second time frame different from said first time frame; and
creates an ordered list of products to be sent to the browser based on said first sorted list being included first in said ordered list of products and said second sorted list of products being included last in said ordered list of products.

48. The system of claim 47, wherein said web server creates a web page containing said ordered list of products.

49. The system of claim 48, wherein said web server sends said web page to the browser to be displayed on the browser.

50. The system of claim 47, wherein said first time frame is twenty-four hours, and said second time frame is greater than twenty-four hours.

51. The system of claim 47, wherein said products are artwork and said list of products are a list of artwork, and said web server:
creates a first sorted list of artwork based on artwork in said list of artwork being available in a first time frame;
creates a second sorted list of artwork based on artwork in said list of artwork being available in a second time frame different from said first time frame;
creates a third sorted list of artwork based on artwork in said list of artwork being available for framing within a third time frame; and
creates an ordered list of artwork to be sent to the browser based on said first sorted list being included first in said ordered list of artwork and said second and third sorted list of artwork being included after said first sorted list in said ordered list of artwork.

52. The system of claim 51, wherein said web server includes said second sorted list in said ordered list of artwork before said third sorted list.

53. A method of filtering products to be displayed on a browser to a user during a session, comprising the steps of:
starting a user session;
receiving a request to filter a list of products;
downloading a filter interface to the browser in the form of a file that can be executed by the browser;
receiving a filter selection criteria from the user selected on said filter interface of the browser;
eliminating products in said list of products that do not meet said filter selection criteria to form a filtered list of products; and
sending said filtered list of products to the browser to be displayed;
wherein said filter interface is not downloaded again during said user session.

54. The method of claim 53 further comprising retaining said filter selection criteria for the user until the user selects other filter selecting criteria on said filter interface.

55. The method of claim 53 further comprising receiving a subsequent request to filter said list of products based on filter selection criteria received from said filter interface.

56. A system for filtering products to be displayed to a user during a session on a browser coupled to the Internet, comprising:
a web server communicatively coupled to the Internet; and
a database communicatively coupled to a database containing information about products;
said web server:
starts a user session;
receives a request to filter a list of products from said products;
downloads a filter interface to the browser in the form of an executable file that can be executed by the browser;
receives a filter selection criteria from the user selected on said filter interface of the browser;
eliminates products in said list of products that do not meet said filter selection criteria to form a filtered list of products; and
sends said filtered list of products to the browser to be displayed;
wherein said filter interface is not downloaded again during said user session.

57. The system of claim 56, wherein said web server stores and retains said filter selection criteria in memory for the user until the user selects other filter selecting criteria on said filter interface.

58. The system of claim 56, wherein said web server receives a subsequent request to filter said list of products based on filter selection criteria received from said filter interface.

59. A method of filtering products to be displayed on a browser to a user during a session, comprising the steps of:
starting a user session;
receiving a filter selection criteria to filter a list of products from the user selected on the browser;
eliminating products in said list of products that do not meet said filter selection criteria to form a filtered list of products;
sending said filtered list of products to the browser to be displayed; and
retaining said filter selection criteria for the user until the user selects other filter selecting criteria on said filter interface.

60. A system for filtering products to be displayed to a user during a session on a browser coupled to the Internet, comprising:
a web server communicatively coupled to the Internet; and
a database communicatively coupled to a database containing information about products;
said web server:
starts a user session;
receives a filter selection criteria to filter a list of products from the user selected on the browser;
eliminates products in said list of products that do not meet said filter selection criteria to form a filtered list of products;
sends said filtered list of products to the browser to be displayed; and
retains said filter selection criteria in memory for the user until the user selects other filter selecting criteria on said filter interface.

61. A method of filtering artwork to be displayed on a browser to a user, comprising the steps of:
receiving filter size criteria in a request to filter a list of artwork displayed on the browser;
filtering artwork in said list of artwork to only include artwork from said list of artwork that meet said filter size criteria to form a filtered list of products; and
sending said filtered list of products to the browser to be displayed.

62. The method of claim 61, wherein said step of filtering is comprised of only including artwork having a portrait type size in said filtered list of artwork.

63. The method of claim 61, wherein said step of filtering is comprised of only including artwork having a landscape type size in said filtered list of artwork.

64. The method of claim 61, wherein said step of filtering is comprised of only including artwork within a custom size in said filtered list of artwork.

65. The method of claim 64, wherein said custom size includes a custom height range.

66. The method of claim 64, wherein said custom size includes a custom width range.

67. The method of claim 61, further comprising creating a web page containing said filtered list of artwork.

68. The method of claim 67, further comprising sending said web page to the browser to be displayed on the browser.

69. The method of claim 61 further comprising downloading a filter interface to the browser that contains an interface for the user to enter said filter size criteria.

70. The method of claim 61 further comprising starting a user session for the user wherein said filter interface is not downloaded again during said user session.

71. A system of filtering artwork to be displayed to a user on a browser coupled to the Internet, comprising the steps of:
a web server communicatively coupled to the Internet; and
a database communicatively coupled to a database containing information about products;
said web server:
receives filter size criteria in a request to filter a list of artwork displayed on the browser;
filters artwork in said list of artwork to only include artwork from said list of artwork that meet said filter size criteria to form a filtered list of products; and
sends said filtered list of products to the browser to be displayed.

72. The system of claim 71, wherein said web server filters said list of artwork to only including artwork having a portrait type size in said filtered list of artwork.

73. The system of claim 71, wherein said web server filters said list of artwork to only including artwork having a landscape type size in said filtered list of artwork.

74. The system of claim 71, wherein said web server filters said list of artwork to only including artwork within a custom size in said filtered list of artwork.

75. The system of claim 74, wherein said custom size includes a custom height range.

76. The system of claim 74, wherein said custom size includes a custom width range.

77. The system of claim 71, wherein said web server creates a web page containing said filtered list of artwork.

78. The system of claim 77, wherein said web server sends said web page to the browser to be displayed on the browser.

79. The system of claim 71 wherein said web server downloads a filter interface to the browser that contains an interface for the user to enter said filter size criteria.

80. The method of claim 71 wherein said web server starts a user session for the user wherein said filter interface is not downloaded again during said user session.
